(19) United States
(12) Patent Application Publication
(10) Pub. No.: US 2010/0222037 A1
(43) Pub. Date: Sep. 2, 2010

(54) Systems, Methods, and Apparatus for Providing Terms and Conditions and Program Enrollment Information to a Mobile Device

(75) Inventor: Bruce Dragt, Marietta, GA (US)

Correspondence Address: SUTHERLAND ASBILL & BRENNAN LLP, 999 PEACHTREE STREET, N.E., ATLANTA, GA, 30309, US

(73) Assignee: First Data Corporation, Greenwood Village, CO (US)

(21) Appl. No.: 12/396,242

(22) Filed: Mar. 2, 2009

(51) Int. Cl. H04M 3/42

(52) U.S. Cl. 455/414.1

(57) ABSTRACT

Systems, methods, and apparatus providing program information to a mobile device are provided by certain embodiments of the invention. According to one embodiment, program information for a program may be associated with an information carrying tone that is transmitted to a mobile device associated with an operator by a tone transmission device. An indication received responsive to the mobile device receiving the information carrying tone can be stored, and at least one entry associating the program and the operator can be stored responsive to receiving the indication. Also according to various aspects, following receipt of the indication, program information can be communicated to the operator, such as terms and conditions or enrollment information, and it may be determined whether the operator desires to enroll in the respective program or accepts terms and conditions.

### CROSS-REFERENCE TO RELATED APPLICATIONS

This application is related to U.S. patent application Ser. No. ______ (Attorney Docket No. 34250-1308) filed Mar. 2, 2009 and entitled “Systems, Methods, and Devices for Administering Consumer Rewards Programs Through the Use of Tones Sent to Mobile Devices”; U.S. patent application Ser. No. ______ (Attorney Docket No. 34250-1309) filed Mar. 2, 2009 and entitled “Systems, Methods, and Apparatus for Providing Promotion Information to a Mobile Device”; U.S. patent application Ser. No. ______ (Attorney Docket No. 34250-1310) filed Mar. 2, 2009 and entitled “Systems, Methods, and Apparatus for Marketing by Communicating Tones to a Mobile Device”; U.S. patent application Ser. No. ______ (Attorney Docket No. 34250-1311) filed Mar. 2, 2009 and entitled “Systems, Methods, and Apparatus for Communicating Information to a Mobile Device in a Broadcast Signal”; U.S. patent application Ser. No. ______ (Attorney Docket No. 34250-1312) filed Mar. 2, 2009 and entitled “Systems, Methods, and Apparatus for Facilitating Communication Between Mobile Devices”; U.S. patent application Ser. No. ______ (Attorney Docket No. 34250-1313) filed Mar. 2, 2009 and entitled “Systems, Methods, and Devices for Prompting Mobile Device Users for Feedback Information Using Tone Transmissions”; U.S. patent application Ser. No. ______ (Attorney Docket No. 34250-1314) filed Mar. 2, 2009 and entitled “Systems, Methods, and Apparatus for Facilitating Transactions Using a Mobile Device”; U.S. patent application Ser. No. ______ (Attorney Docket No. 34250-1316) filed Mar. 2, 2009 and entitled “Systems, Methods, and Devices for Communicating Supplemental Information to Mobile Devices”; U.S. patent application Ser. No. ______ (Attorney Docket No. 34250-1325) filed Mar. 2, 2009 and entitled “Systems, Methods, and Apparatus for Receiving Information by a Mobile Device”; U.S. patent application Ser. No. ______ (Attorney Docket No. 34250-1326) filed Mar. 2, 2009 and entitled “Systems, Methods, and Apparatus for Providing Information to a Mobile Device”; U.S. patent application Ser. No. ______ (Attorney Docket No. 34250-1327) filed Mar. 2, 2009 and entitled “Systems, Methods, and Apparatus for Receiving Promotion Information by a Mobile Device”; and U.S. patent application Ser. No. ______ (Attorney Docket No. 34250-1328) filed Mar. 2, 2009 and entitled “Systems, Methods, and Devices for Processing Feedback Information Received from Mobile Devices Responding to Tone Transmissions.” Each of these applications is incorporated by reference herein in its entirety.

### FIELD OF THE INVENTION

Embodiments of the invention relate generally to mobile devices, and more particularly, to systems, methods, and apparatus providing terms and conditions and program enrollment information to a mobile device.

### BACKGROUND OF THE INVENTION

A wide variety of marketing and advertising methods and techniques are utilized to provide information, such as advertisements, product information, coupons, rebates, sale information, and/or discount offers, to a consumer. Examples of traditional marketing techniques include the use of billboards, posters, flyers, radio advertisements, television advertisements, mailings, and coupon dispensers. More modern marketing techniques, including the use of modern technologies and communication media including the use of email, the Internet, etc. Each of these examples may provide a consumer with marketing or other program information, such as an offer to participate or enroll in a marketing program, to open an account, and the like. As part of participating in marketing programs, however, the steps of effectively and efficiently enrolling individuals, such as to capture a person's assent to terms and conditions of the marketing program.

However, conventional communication techniques such as advertisements, mailings, flyers, and email communications typically require multiple steps be performed by the consumer to both receive enough information and indicate their desire to enroll and agreement to corresponding terms and conditions of the program. However, these conventional techniques fall short of enticing the consumer with sufficient information, while at the same time increasing the conveniences on the consumer and decreasing the costs and efforts of the entity maintaining the marketing or other program. First, with some marketing techniques, such as billboards, posters, radio advertisements, and television advertisements, the consumer is not provided with information that they can review at a later point in time. The consumer may also desire additional information for regarding the program that is not provided by a billboard or poster. Additionally, with conventional marketing techniques, the consumer may be provided with information that is easily misplaced or lost and, therefore, not readily accessible at a subsequent point in time. The entities offering or maintaining marketing programs or other programs can benefit from obtaining consumer's actual, express desire to participate and consent to any associated terms and conditions; however, doing so can be cumbersome and impractical with these conventional techniques.

With the widespread use of mobile devices, such as cellular phones or smart phones, new methods for providing marketing information to consumers have been developed. For example, text message advertisements may be sent to a mobile device. Conventional mobile marketing techniques, such as text message advertisements, may have costs associated with them that a user of a mobile device is unwilling to pay. Moreover, these new mobile marketing techniques are limited to communications via the single channel of cellular communications and typically only with individuals that have expressly opted for receiving the communications. Accordingly, these conventional mobile marketing techniques may not reach a given segment of a target audience.

Therefore, a need exists in the art for systems, methods, and apparatus for addressing some or all of the shortcomings and limitations of existing marketing and other program communication techniques.

### SUMMARY OF THE INVENTION

Some or all of the above needs and/or problems may be addressed by certain embodiments of the invention. Embodiments of the invention may include systems, methods, and apparatus providing program information to a mobile device. According to one embodiment, a method for communicating program information to a mobile device is provided. The method may include associating program information for a program with an information carrying tone that is transmitted to a mobile device associated with an operator by a tone transmission device. The method may further include receiving an indication responsive to the mobile device receiving the information carrying tone, and storing at least one entry associating the program and the operator responsive to receiving the indication.

According to another embodiment, a method for communicating program information to a mobile device is provided. The method may include receiving an indication from a mobile device associated with an operator, wherein the indication identifies an information carrying tone transmitted to the mobile device. The method may further include determining that the information carrying tone is associated with program information, and associating, by the central information source, the operator and the program information.

According to yet another embodiment, a system for communicating a promotion to a mobile device is provided. The system may include a network interface operable to connect with a network, memory including computer-executable instructions to communicate program information, and at least one processor in communication with the memory and the network interface. The processor may further be operable to execute the computer-executable instructions to associate program information for a program with an information carrying tone that is transmitted to a mobile device associated with an operator by a tone transmission device, receive an indication responsive to the mobile device receiving the information carrying tone, and store in the memory at least one entry associating the program and the operator responsive to receiving the indication.

Additional systems, methods, apparatus, features, and aspects are realized through the techniques of various embodiments of the invention. Other embodiments and aspects of the invention are described in detail herein and are considered a part of the claimed invention. Other advantages and features can be understood with reference to the description and to the drawings.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram of one example system that may facilitate the communication of information to a mobile device, according to an illustrative embodiment of the invention.

FIG. 2 is a diagram of one example data flow of transmitting a tone and retrieving information associated with the tone, according to an illustrative embodiment of the invention.

FIG. 3 is a schematic diagram of yet another example system that may facilitate the communication of information to a mobile device, according to an illustrative embodiment of the invention.

FIG. 4 is a block diagram of data that may be included in an example tone, according to an illustrative embodiment of the invention.

FIG. 5 is a flow chart of one example method for processing a tone on a mobile device, according to an illustrative embodiment of the invention.

FIG. 6 is a flow chart of one example method for processing program information at an information source that is associated with a tone output to a mobile device by a tone transmission device, according to an illustrative embodiment of the invention.

FIG. 7 is a flow chart of one example method for processing program information with multiple information sources that is associated with a tone output to a mobile device by a tone transmission device, according to an illustrative embodiment of the invention.

### DETAILED DESCRIPTION OF EMBODIMENTS OF THE INVENTION

Example embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

In accordance with embodiments of the invention, systems, methods, and apparatus providing program information, such as terms and conditions information and associated program enrollment information, to mobile device operators are provided. The widespread use of mobile devices, such as cellular phones or smart phones, provides a new, very effective channel to reach potential customers to transmit information, such as program information. Moreover, mobile devices provide a relatively simple and convenient means to request additional information and feedback from potential customers, as well as automatically monitor downstream uses tied to the program information transmitted to the mobile devices.

The term “program” is used herein to generally refer to any event or activity that in which an individual can participate and that is administered or sponsored by an entity. Example programs can include, but are not limited to, marketing campaigns, promotional events, membership programs, financial accounts, sales or offers of goods or services, informational services, news services, product update services, contests, event registration, and the like. The term “program information” is used herein to generally refer to information about or associated with one or more programs, and can include, but is not limited to, terms and conditions, special rules, exclusions, enrollment information, legal terms, contractual information, program details, product description, account information, membership information, cost, entity information, sponsor information, event information, and the like.

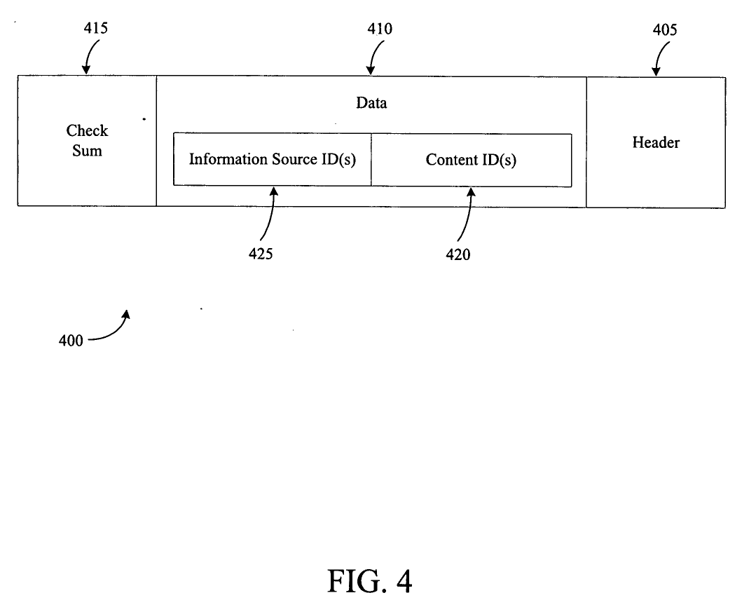

As used herein, the term “tone” may refer to a tone carrying information that may be communicated or transmitted to a mobile device by a tone transmission device. The terms “tone” and “information carrying tone” may be used interchangeably herein. A wide variety of methods and/or techniques may be utilized to facilitate the communication of a tone from a tone transmission device to a mobile device. In certain embodiments of the invention, a tone may be output by one or more suitable output devices associated with the tone transmission device, for example, one or more speakers, and the tone may be received by one or more suitable input devices associated with the mobile device, for example, a microphone. A tone may be a wave, such as an elastic wave, a primary wave or P-wave, that is propagated between the tone transmission device and the mobile device. In certain embodiments of the invention, a tone may be a vibration wave that is propagated though a solid, liquid, or gas. For example, in various embodiments of the invention, a tone may be a sound wave that is emitted or otherwise output by the tone transmission device for reception by a mobile device. Tones in accordance with embodiments of the invention may have a wide variety of different frequencies and/or amplitudes as desired. For example, in some embodiments, a tone may be a sound wave that is within a range that may be detected by the human ear, for example, a sound wave with a frequency between approximately 20 hertz and approximately 20 kilohertz. In such an example embodiment of the invention, it may be desirable to have the tone be produced at a frequency range that is not detectable by the naked ear for at least a significant portion of the human population (e.g., a frequency range of 17 kilohertz-20 kilohertz). In other embodiments, a tone may be a sound wave that is outside the normal range that may be detected by the human ear, for example, a sound wave with a frequency above approximately 21 kilohertz. In these embodiments, a tone may be transmitted to a mobile device without being aurally detected by a user of the mobile device. Once received, the tone may be processed by the mobile device to extract the information included in the tone. Information embedded in or otherwise carried by the tone can include one or more location identifiers, or other unique identifiers, as described in more detail with reference to FIG. 4.

As used herein, the term “tone transmission device” may be any device, system, apparatus, or combination thereof that facilitates the communication of a tone to a mobile device. A tone transmission device may facilitate mobile marketing by communicating tones to a mobile device that are associated with various marketing information. Additionally, for purposes of this disclosure, the terms “tone transmission device” and “tone transmission system” may be used interchangeably. Examples of tone transmission devices include, but are not limited to, devices that are situated within a poster, billboard, etc., devices that are situated within a retail location (e.g., devices situated on the shelves of a grocery store), mobile devices, radios, televisions, speaker systems, public broadcast systems, public announcement system, point of sale terminals, computers, projectors, etc. Some example tone transmission devices and tone transmission systems are discussed in greater detail below.

As used herein, the term “mobile device” may refer to any mobile device that is operable to receive a tone from a tone transmission device. Mobile devices may be devices that are carried by a target user and information, such as marketing information, may be communicated to the user via the mobile devices. Examples of mobile devices include, but are not limited to, cellular phones, iPhones, smart phones, personal digital assistants (PDA's), pagers, digital audio players, handheld portable computing devices, digital tablets, laptop computers, etc. Additionally, for purposes of this disclosure, the terms “mobile device,” “mobile communications device,” “mobile phone,” “cellular phone,” and “cell phone” may be used interchangeably.

Various embodiments described herein can include receiving program information on a mobile device. According to one embodiment, the transmission of program information can be initiated by communicating a tone, such as an information carrying tone, to a mobile device, whereby the tone includes a location identifier that is associated with the program. In addition, embodiments may further include transmitting via the mobile device an user's responses and/or input to the mobile device, which may be further processed by one or more entities, such as a back-end processor capable of maintaining location identifier and associated program information, and/or merchants, marketers, service providers, financial institutions, or other entities with which respective programs are associated. Accordingly, interacting with a mobile device to transmit program information or any other associated information, creates a beneficial channel for interacting with potential customers.

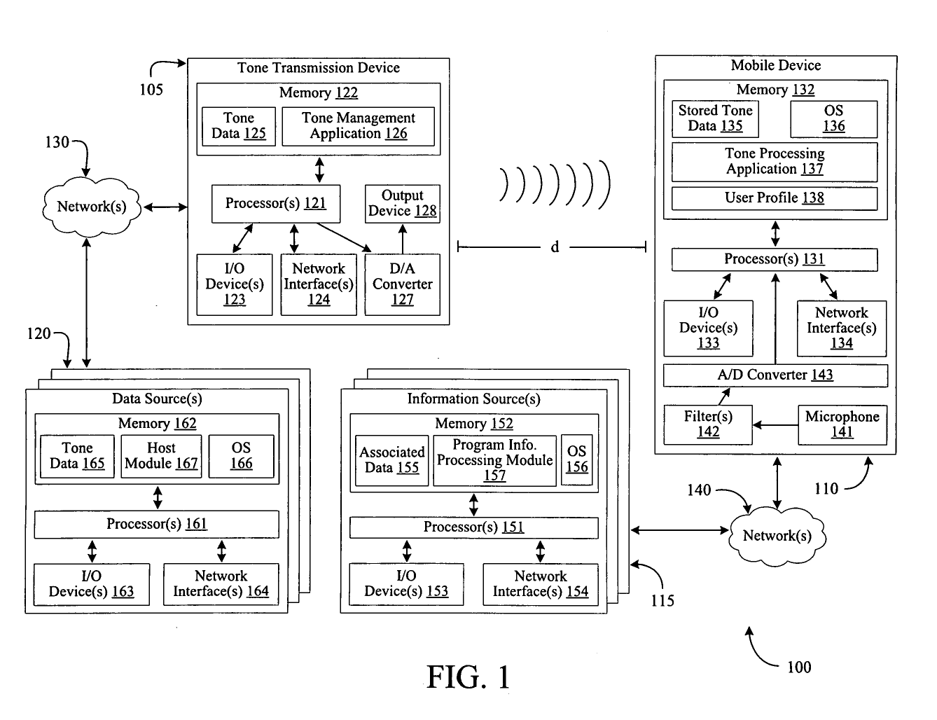

Various tone transmission devices may be operable to transmit information carrying tones with associated program terms and conditions information, such as a television transmitting audiovisual content including an information carrying tone, a radio transmitter transmitting radio content including an information carrying tone, or a stand-alone tone generation device having the primary purpose to generate and/or transmit information carrying tones, such as may be used in retail displays or other advertisement displays, for example, as described with reference to FIG. 1.

For example, while watching a television broadcast, such as an advertisement, a message may be played that indicates a certain program may be available for the viewer's enrollment. The message may indicate that if the viewer elects to receive an information carrying tone being broadcast through the television they may receive additional program details and/or expressly elect to participate and agree to the program's terms and conditions. Thus, if a viewer so chooses, upon receiving the information carrying tone by the mobile device, the mobile device may then communicate with a back-end processor (also referred to herein as an “information source”) to receive additional program information and/or to elect to participate and accept the terms and conditions.

Upon receiving an information carrying tone by the mobile device, the mobile device and associated applications can perform processing to extract the information carried by the tone. In example embodiments, the tone data may include at least one location identifier or other unique identifier that is associated by a back-end processing system with additional program information. Thus, in response to extracting the location identifier from the tone, the mobile device may transmit a request to another system, such as a back-end processor, merchant, marketer, service provider, financial institution, or other entity to receive additional program information or to indicate the viewer's acceptance of associate program terms and conditions. The request may include a request for additional information, such as for terms and conditions information or program enrollment information associated with a location or other unique identifier extracted from the tone. The location identifier or other unique identifier may facilitate the back-end processor or other entity to identify the associated program information and/or performing additional program processing. In one example embodiment, the user may provide input to the mobile device, such as whether the user agrees to program terms and conditions and/or whether the user wishes to be enrolled or otherwise participate in the program.

One or more entities can facilitate the generation, transmission, processing, and other management of program communications using the information carrying tones. For example, a central information source, such as a back-end processor, may create tones and associate location identifiers therewith. A central information source may also facilitate the transmission of information carrying tones and location identifiers, such as by coordinating with a television or radio broadcaster or by providing standalone tone transmission devices at merchants or with other advertising media. In some embodiments, a central information source may interact with one or more third party entities, such as a merchants, service providers, marketers, and the like, for which programs are being provided. For example, a central information source may communicate with a third party entity (also referred to interchangeably herein as a “third party information source”), sending information received from mobile a device in association with an information carrying tone, or requesting information to send to a mobile device.

A wide variety of different systems may be utilized as desired in various embodiments of the invention to communicate information to a mobile device. A few example system are discussed below with reference to FIGS. 1-7.

Illustrative System Overview

FIG. 1 is a schematic diagram of one example system 100 that may facilitate the communication of information to a mobile device 110, according to an illustrative embodiment of the invention. The system 100 may be utilized to facilitate the communication of a wide variety of different information to a mobile device 110 through the use of communicating one or more tones to the mobile device 110. The system 100 may include a tone transmission device 105, a mobile device 110, and one or more information sources 115.

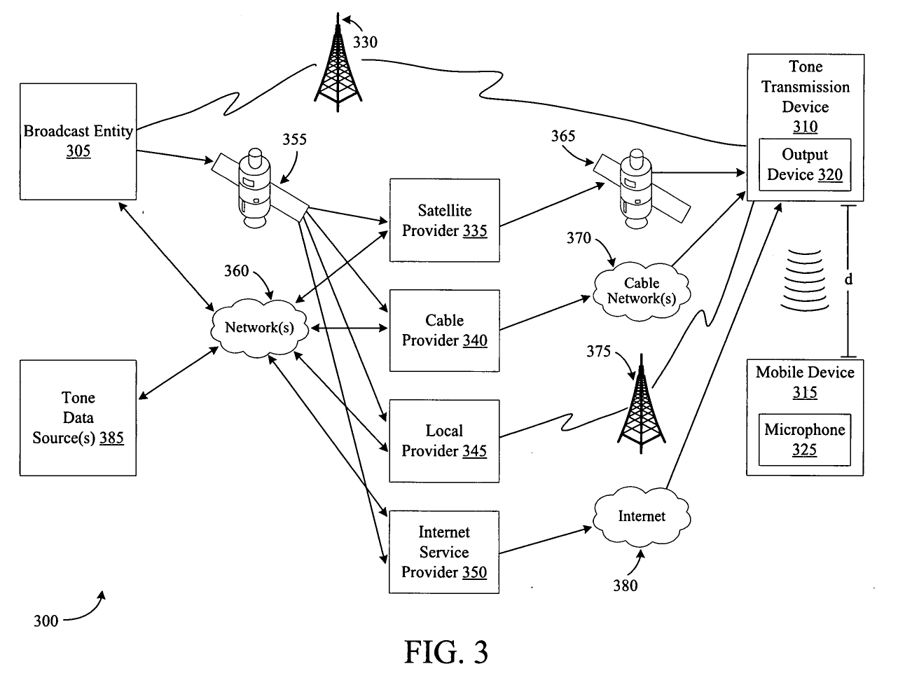

The tone transmission device 105 may be any suitable or appropriate device or system that facilitates the communication of a tone to a mobile device 110. In this regard, the tone transmission device 105 may facilitate mobile marketing. The tone transmission device 105 may be situated or placed in a wide variety of different locations or environments as desired in various embodiments of the invention. For example, the tone transmission device 105 may be incorporated into or situated proximate to a poster, billboard, sign, or other advertisement. The tone output by the tone transmission device 105 may be associated with a product or service that is referenced by the poster, billboard, sign, or other advertisement. As another example, the tone transmission device 105 may be situated at a merchant location, such as, a retail establishment. The tone transmission device 105 may be incorporated into or situated proximate to one or more products at the merchant location. For example, the tone transmission device 105 may be located on a shelf at the merchant location next to a product associated with a tone that is output by the tone transmission device 105 or the transmission device 105 may be located next to or incorporated into a cashier's station or kiosk inside the merchant location. As another example, the tone transmission device 105 may be any conventional television, radio, computer, or projector operable to transmit content, such as video and/or audio content, as further described with reference to FIG. 3. As another example, the tone transmission device 105 may be a speaker system, public announcement system, or public broadcasting system that is situated within a merchant location, a sporting venue, or some other location. As yet another example, the tone transmission device 105 may be a mobile device that is operable to communicate a tone to another mobile device 110. As another example, the tone transmission device 105 may be a portable audio device (e.g., iPod, portable radio, etc.), a radio, a television, or other device that is capable of outputting a tone.

In certain embodiments of the invention, the size and/or dimensions of the tone transmission device 105 may be based at least in part on the application of the tone transmission device 105. For example, if the tone transmission device 105 is incorporated into a poster, the tone transmission device 105 may have relatively small dimensions that facilitate its incorporation into the poster. As another example, a tone transmission device 105 that is situated on or near a shelf at a merchant location may have relatively small dimensions. For example, the tone transmission device 105 may have a size that is smaller than or approximately equal to that of a conventional coupon holder. In yet another example, the tone transmission device 105 may be any conventional television, radio, computer, or projector, as further described with reference to FIG. 3. Additionally, the tone transmission device 105 may utilize a wide variety of different power sources as desired in various embodiments of the invention, for example, battery power, a direct current power source, an alternating current power source, or a network provided power source (e.g., power provided via a telephone line).

The tone transmission device 105 may be a processor driven device that facilitates the outputting and communication of a tone that may be received by a mobile device 110. For example, the tone transmission device 105 may include any number of special purpose computers or other particular machines, application specific circuits, microcontrollers, personal computers, minicomputers, and the like. In certain embodiments, the operations of the tone transmission device 105 may be controlled by computer-executed or computer-implemented instructions that are executed by one or more processors associated with the tone transmission device 105. The instructions may be embodied in one or more software components as desired in various embodiments of the invention. The execution of the instructions may form a special purpose computer or other particular machine that is operable to communicate a tone to a mobile device 110. The one or more processors that control the operations of the tone transmission device 105 may be incorporated into the tone transmission device 105 and/or in communication with the tone transmission device 105 via one or more suitable networks. In certain embodiments of the invention, the operations and/or control of the tone transmission device 105 may be distributed amongst several processing components.

The tone transmission device 105 may include one or more processors 121, one or more memory devices 122, one or more input/output (I/O) interface(s) 123, and one or more network interface(s) 124. The one or more memory devices 122 may be any suitable memory devices, for example, caches, read only memory devices, random access memory devices, magnetic storage devices, etc. The one or more memory devices 122 may store data, executable instructions, and/or various program modules utilized by the tone transmission device 105, for example, tone data 125 and/or a tone management application 126. The tone data 125 may include stored data associated with a tone that is output by the tone transmission device. For example, the tone data may include stored digital data associated with a tone, such as, a Waveform audio format (WAV) file, MPEG-1 Audio Layer 3 (MP3) file, Moving Picture Experts Group (MPEG) file, Audio Interchange File Format (AIFF) file, Advanced Audio Coding (AAC) file, Apple Lossless file, or other digital media file format. As another example, the tone data may include stored analog data associated with a tone, for example, magnetically stored analog data. Additionally, in certain embodiments of the invention, data associated with a tone may be received by the tone transmission device 105 and output by the tone transmission device 105 without being stored in one or more memory devices 122. Thus, in some embodiments of the invention the tone transmission device 105 does not include the one or more memory devices 122.

In certain embodiments of the invention, the tone transmission device 105 may include a tone management application 126. The tone management application 126 may include computer-executable instructions that facilitate the management of one or more tones by the tone transmission device 105. For example, the tone management application 126 may facilitate and/or control the receipt of tone data or other information associated with a tone, the generation of tone data, the storage of tone data, the accessing of stored tone data, the conversion of tone data into a form that may be output by the tone transmission device 105, and/or the output of a tone by the tone transmission device 105. In certain embodiments, the conversion of tone data into a form that may be output by the tone transmission device 105 may transform digital tone data into analog data that may be output by one or more suitable output devices, for example, one or more speakers. In certain embodiments of the invention, the tone management application 126 may also facilitate and/or control network communication between the tone transmission device 105 and one or more external devices, such as, one or more data sources 120. Although the tone management application 126 is illustrated as a single software component, the tone management application 126 may include any number of software components, modules, and/or applications as desired in various embodiments of the invention.

The one or more I/O interfaces 123 may facilitate communication between the tone transmission device 105 and one or more input/output devices, for example, a universal serial bus port, a serial port, a disk drive, a CD-ROM drive, infrared receiver, and/or one or more user interface devices, such as, a display, keyboard, keypad, mouse, control panel, touch screen display, remote control, microphone, etc. that facilitate user interaction with the tone transmission device 105. The one or more I/O interfaces may be utilized to receive or collect tone data from a wide variety of input devices. For example, tone data may be received from a portable memory device (e.g., thumb drive, portable hard drive, etc.) via the one or more I/O interfaces. Following receipt of the tone data via the one or more I/O interfaces, the received tone data may be processed by the tone management application 126 and stored in a memory device 122 associated with the tone transmission device 105. Additionally, in certain embodiments, the one or more I/O interfaces may be utilized to receive user input from a user of the tone transmission device 105, for example, a programmer of the tone transmission device 105. In this regard, one or more user preferences associated with the operation of the tone transmission device 105 may be received and processed. In certain embodiments of the invention, user input may be received by the tone transmission device 105 indicating a desire to have a tone output by the tone transmission device 105. For example, a user may press a button or activate a sensor associated with a tone transmission device 105, thereby causing the tone transmission device to output a tone.

The one or more network interfaces 124 may facilitate connection of the tone transmission device 105 to one or more suitable networks 130, for example, a local area network, a wide area network, a Bluetooth enabled network, a Wi-Fi network, a radio frequency network, the Internet, a telephone network, a broadcast network, a cellular network, any wired network, any wireless network, etc. In this regard, the tone transmission device 105 may receive tone data and/or user input from one or more external devices, network components, and/or systems via the one or more networks 130. For example, the tone transmission device 105 may receive tone data from one or more data sources 120 via the one or more networks 130. As one example, if the tone transmission device 105 is located at a merchant location, then the tone transmission device 105 may receive tone data from one or more data sources 120 located at the merchant location via a local area network. As another example, if the tone transmission device 105 is a television, then the tone transmission device 105 may receive tone data in association with a television signal, transmission, or broadcast received via a suitable television network (e.g., broadcast, cable, satellite, IP television, Internet, etc.). As yet another example, if the tone transmission device 105 is a radio, then the tone transmission device 105 may receive tone data in association with a radio signal, transmission, or broadcast via a suitable radio network (e.g., broadcast, satellite, Internet, etc.). As yet another example, if the tone transmission device 105 is a mobile device, then the tone transmission device 105 may receive tone data via communication over a cellular network or via an Internet connection.

According to an aspect of the invention, the tone transmission device 105 may output a tone for receipt by a mobile device 110. The tone transmission device 105 may output the tone via one or more suitable output devices 128, for example, one or more speakers. In certain embodiments of the invention, the tone management application 126 may direct and/or control the access of stored tone data 125 and the processing of the accessed tone data 125 to derive the tone that is output by the one or more output devices 128. For example, digital tone data 125 may be accessed from memory 122 and processed through a digital-to-analog converter 127 to derive the tone that is output by the one or more output devices 128. In this regard, the stored tone data 125 may be transformed into a tone that may be output by the tone transmission device 105 for receipt by a mobile device. In other embodiments of the invention, the tone transmission device 105 may receive tone data in a broadcast stream, such as a radio or television broadcast stream, and the tone transmission device may output the tone data as a tone in the audio output of the tone transmission device 105. For example, a television broadcast signal may include embedded tone information that is output by one or more speakers of a television as part of the audio output of the received television broadcast signal.

Embodiments of the invention may include tone transmission devices with more or less than the components illustrated for the tone transmission device 105 illustrated in FIG. 1. The description of the tone transmission device 105 of FIG. 1 is provided by way of example only and is not intended to be limiting.

With continued reference to FIG. 1, the mobile device 110 may be any suitable or appropriate device or system that facilitates the receipt of a tone from a tone transmission device 105 and the processing of the received tone. In this regard, the mobile device 110 may receive mobile marketing information through the receipt of one or more tones. The mobile device 110 may facilitate the receipt of tones from any number of tone transmission devices 105 in a wide variety of different locations or environments as desired in various embodiments of the invention. Once a tone is received by the mobile device 110, the tone may be processed by the mobile device 110 to extract information included in the tone, such as, one or more location identifiers that reference additional information associated with the tone. The extracted information may be utilized to access one or more information sources 115 to obtain at least a portion of the additional information associated with the tone.

Tones may be associated with a wide variety of different types of additional information that may be accessed by the mobile device 110 from one or more information sources 115. In one embodiment, additional information that may be associated with tones include, but is not limited to, program information, such as terms and conditions and enrollment information. Additionally, information extracted from a tone may facilitate the connection of the mobile device 110 to a website or other network site for a wide variety of purposes, including but not limited, enrolling or otherwise indicating a desire to participate in a program, and/or accepting or rejecting previously communicated terms and conditions associated with the program.

The mobile device 110 may be a processor driven device that facilitates the receipt of tones from tone transmission devices 105 and the processing of the received tones. For example, the mobile device 110 may include any number of special purpose computers or other particular machines, application specific circuits, microcontrollers, and the like. In certain embodiments, at least a portion of the operations of the mobile device 110 may be controlled by computer-executed or computer-implemented instructions that are executed by one or more processors associated with the mobile device 110. The instructions may be embodied in one or more software components as desired in various embodiments of the invention. The execution of the instructions may form a special purpose computer or other particular machine that is operable to receive and process tones. Additionally, in certain embodiments of the invention, the operations and/or control of the mobile device 110 may be distributed amongst several processing components.

The mobile device 110 may include one or more processors 131, one or more memory devices 132, one or more input/output (I/O) interface(s) 133, and one or more network interface(s) 134. The one or more memory devices 132 may be any suitable memory devices, for example, caches, read only memory devices, random access memory devices, magnetic storage devices, etc. The one or more memory devices 132 may store data, executable instructions, and/or various program modules utilized by the mobile device 110, for example, stored tone data 135 that is received by the mobile device 110, an operating system 136, a tone processing application 137, and/or a user profile 138. The stored tone data 135 may include information associated with and/or extracted from one or more tones that are received by the mobile device 110. For example, the stored tone data 135 may include one or more location identifiers that are extracted from received tones. As another example, the stored tone data 135 may include additional information associated with tones that is received from one or more information sources 115.

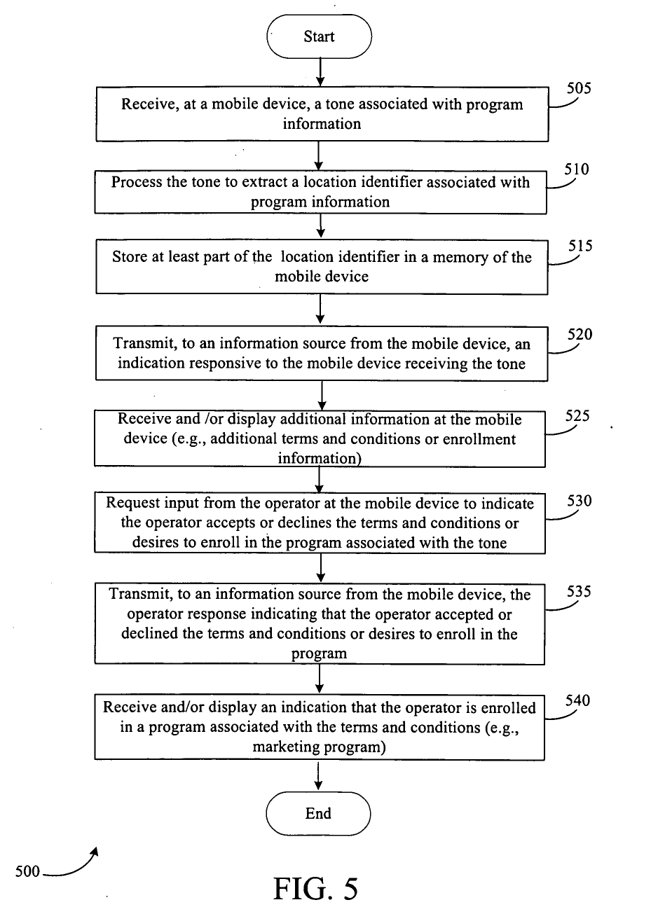

In certain embodiments of the invention, the mobile device 110 may include one or more software modules, such as an operating system 136 and/or a tone processing application 137. The operating system 136 may control the general operation of the mobile device 110, for example, the completion of telephone calls, the maintenance of an address book, the accessing of the Internet via a mobile browser application, etc. The operating system 136 may also facilitate the execution of other software modules by the one or more processors 131, for example, the tone processing application 137. The tone processing application 137 may include computer-executable instructions that facilitate the receipt and processing of one or more tones by the mobile device 110. For example, the tone processing application 137 may facilitate and/or control the receipt of tones from one or more tone transmission devices 105, the processing of received tones to extract one or more location identifiers associated with the tones, the communication of requests for additional information associated with a tone from one or more information sources 115, the receipt of additional information from one or more information sources 115, the processing of received additional information, the storage of received additional information, and/or the subsequent access and/or processing of stored additional information, such as is described with reference to FIG. 5, for example. In certain embodiments of the invention, the tone processing application 137 may also facilitate and/or control network communication between the mobile device 110 and one or more external devices, such as, one or more information sources 115. Although the tone processing application 137 is illustrated as a single software component, the tone processing application 137 may include any number of software components, modules, and/or applications as desired in various embodiments of the invention.

The user profile 138 may include one or more preferences and/or other information associated with one or more users of the mobile device 110. In certain embodiments, the user profile 138 may include one or more user preferences associated with types of desired tones and/or additional information that may be received and processed by the mobile device 110. For example, the user profile 138 may include preferences indicating that certain tones and/or additional information should be or should not be received and/or processed by the mobile device 110. In this regard, tones and/or additional information may be filtered by the mobile device 110. A wide variety of different preferences and/or criteria may be utilized as desired in various embodiments, including but not limited to, merchant criteria, merchant class or merchant type criteria, broadcaster criteria, marketing source criteria, etc. As another example, the user profile 138 may include one or more preferences associated with the manner in which tones and/or additional information should be processed by the mobile device 110. Moreover, according to one embodiment, the user profile 138 may include information associated with the user of the mobile device 110, such as, but not limited to, name information, username, account information, billing information, and the like.

The one or more I/O interfaces 133 may facilitate communication between the mobile device 110 and one or more input/output devices, for example, one or more user interface devices, such as, a display, keypad, control panel, touch screen display, remote control, microphone, etc. that facilitate user interaction with the mobile device 110. In this regard, one or more user preferences associated with the operation of the mobile device 110 may be received and processed.

The one or more network interfaces 134 may facilitate connection of the mobile device 110 to one or more suitable networks 140, for example, a cellular network, a local area network, a Bluetooth enabled network, a Wi-Fi network, a radio frequency network, a wide area network, the Internet, any wired network, any wireless network, etc. In this regard, the mobile device 110 may receive additional information or data associated with tones from one or more external devices, network components, and/or systems via the one or more networks 140. The mobile device 110 may then process the received additional information and communicate with the one or more external devices, network components, and/or systems via the one or more networks 140. For example, the mobile device 110 may receive a tone from a tone transmission device 105 and extract one or more location identifiers from the received tone. The mobile device 110 may utilize the one or more extracted location identifiers to access one or more information sources 115 via a cellular network or mobile Internet browser and receive additional information associated with the tone. The mobile device 110 may utilize a wide variety of different techniques, methods, and/or systems to communicate with the one or more information sources 115. For example, a mobile Internet browser or other specific purpose or dedicated application may facilitate communication between the mobile device 110 and the one or more information sources 115. As another example, short message service (SMS) communications may be utilized to facilitate communication between the mobile device 110 and the one or more information sources 115.

According to an aspect of the invention, the mobile device 110 may receive and process one or more tones from any number of tone transmission devices 105. A tone may be output by a tone transmission device 105 and the mobile device 110 may identify and receive the output tone within a predetermined distance or range “d” from the tone transmission device 105. A tone transmission device 105 may have a wide variety of different ranges as desired in various embodiments of the invention, for example, a range of approximately three feet. In certain embodiments of the invention, the tone processing application 137 of the mobile device 110 may control the receipt of tones by the mobile device 110. For example, a setting or option associated with the tone processing application 137 may control the receipt of tones by the mobile device 110. When a user indicates that the setting or option should be set to allow tones to be received, the receipt of tones may be facilitated by the mobile device 110. However, when a user indicates that the setting or option should be set to disallow the receipt of tones, then the mobile device 110 will not process any tones output by a tone transmission device 105. In some embodiments, tones may be received and processed when a user of the mobile device opens, executes, or leaves on the tone processing application 137. In other embodiments, tones may be received and processed only when a user selects an option within the tone processing application 137 indicating that tones should be received.

The mobile device 110 may include one or more input devices that facilitate the receipt of tones. For example, a microphone 141 associated with the mobile device 110 may be utilized to receive tones that have been output by one or more speakers associated with a tone transmission device 105. After being received by the microphone 141, a tone may be passed through one or more filters, for example, one or more band pass filters that facilitate the isolation of the tone from other transmissions received by the microphone 141. The filtered tone may then be passed through one or more analog-to-digital converters 143 prior to being communicated to the one or more processors 131. In this regard, an analog tone may be transformed into digital information that may be processed by the tone processing application 137. The tone processing application may 137 process the digital information associated with the tone, and the tone processing application 137 may extract one or more location identifiers and/or other data associated with the tone. In certain embodiments of the invention, the tone processing application 137 may further filter the received digital information with one or more digital filters or software filters.

Once the one or more location identifiers have been extracted by the tone processing application 137, the tone processing application 137 may utilize the one or more location identifiers to receive additional information associated with the tone, for example, program enrollment and terms and conditions information. The one or more location identifiers may facilitate the identification of one or more information sources 115 from which the additional information associated with the tone may be received. The tone processing application 137 may direct the communication of a request for the additional information to at least one information source 115 via a suitable network 140. The request may include at least one location identifier and/or an identifier of the mobile device 110, for example, a telephone number associated with the mobile device 110, a universal integrated circuit card (UICC) identifier, a unique device identifier (UDID), a subscriber identity module (SIM) card identifier, an international mobile subscriber identity (IMSI) number associated with the mobile device 110, or any other identifier that facilitates communication with an information source (e.g., a First Data Mobile Gateway identifier). Responsive to the request, the mobile device 110 may receive the requested additional information associated with the tone via the network 140. The tone processing application 137 may process at least a portion of the received additional information. Additionally, the tone processing application 137 may direct the storage of the one or more location identifiers and/or the received additional information in the memory 132 of the mobile device 110. As desired, at least a portion of the received additional information may be presented or output to a user of the mobile device 110 via one or more suitable output devices associated with the mobile device 110, for example, a display, speaker, headset, or an output device external to the mobile device 110.

Additional information associated with a tone may be utilized by a mobile device 110 for a wide variety of different purposes as desired in various embodiments of the invention. For example, additional information may include program information, such as may be beneficial to the consumer to describe the program, or terms and conditions, such as may include legal terms, program limitations, particulars, and the like, and at least a portion of the additional information may be formatted for and displayed to a user of the mobile device 110 via a suitable output device associated with the mobile device 110 (e.g., an LCD display). As another example, additional information may facilitate the display of accepting or rejecting terms and conditions information on an output device associated with the mobile device 110. User input associated with the terms and conditions information may be received and processed. In other embodiments, the additional information may be stored by the mobile device 110 and utilized in a subsequent transaction associated with the respective program. For example, the additional information may include a program account or membership number, and the number or other identifier may be accessed from memory by the mobile device 110 at a point of sale terminal. The number or other identifier may be displayed on a display of the mobile device, scanned from the display at the point of sale terminal, communicated from the mobile device 110 to the point of sale terminal via a suitable network connection, or communicated to an intermediary device that interacts with the point of sale terminal, such as, a contactless transaction device associated with the mobile device 110. In some embodiments, the program account or membership number may include a promotional code that may be displayed to a user and/or communicated to a point of sale terminal.

Embodiments of the invention may include mobile devices 110 with more or less than the components illustrated for the mobile device 110 illustrated in FIG. 1. The description of the mobile device 110 of FIG. 1 is provided by way of example only and is not intended to be limiting.

With continued reference to FIG. 1, the system 100 may include any number of information sources 115 that are operable to provide additional information associated with tones to a mobile device. The additional information may be communicated to a mobile device 110 by an information source 115 in response to a request for the additional information, as discussed in greater detail above. In certain embodiments of the invention, a mobile device 110 may communicate requests directly to any number of information sources 115. In other embodiments, the mobile device 110 may communicate requests to a single information source or a central information source. The central information source may communicate with other information sources as desired in various embodiments of the invention and collect additional information that is communicated to the mobile device 110. Additionally or alternatively, the central information source may establish direct communication between the mobile device 110 and another information source, for example, via handing off a network session between the mobile device 110 and the central information source to another information source.

An information source 115 may be a processor driven device or network entity that facilitates the receipt of a request for additional information or data associated with a tone, the accessing of the additional information, and the communication of the additional information to another component of the system 100 in response to the received request for the additional information. For example, the additional information may be communicated to the mobile device 110 or to another information source 115 in response to a request for the additional information. The information source 115 may include any number of processors and/or processing components as desired in various embodiments of the invention. For example, the information source 115 may include any number of special purpose computers or other particular machines, application specific circuits, microcontrollers, personal computers, servers, and the like. In certain embodiments, at least a portion of the operations of the information source 115 may be controlled by computer-executed or computer-implemented instructions that are executed by one or more processors associated with the information source 115. The instructions may be embodied in one or more software components as desired in various embodiments of the invention. The execution of the instructions may form a special purpose computer or other particular machine that is operable to receive and process requests for additional information associated with tones. Additionally, in certain embodiments of the invention, the operations and/or control of the information source 115 may be distributed amongst several processing components.

The information source 115 may include one or more processors 151, one or more memory devices 152, one or more input/output (I/O) interface(s) 153, and one or more network interface(s) 154. The one or more memory devices 152 may be any suitable memory devices, for example, caches, read only memory devices, random access memory devices, magnetic storage devices, databases, etc. The one or more memory devices 152 may store data, executable instructions, and/or various program modules utilized by the information source 115, for example, additional information 155 associated with tones, an operating system 156, and/or a program information processing module 157. The stored additional data 155 may include any information associated with a tone that may be received by a mobile device 110. For example, the stored additional data 155 may include marketing information associated with a tone.

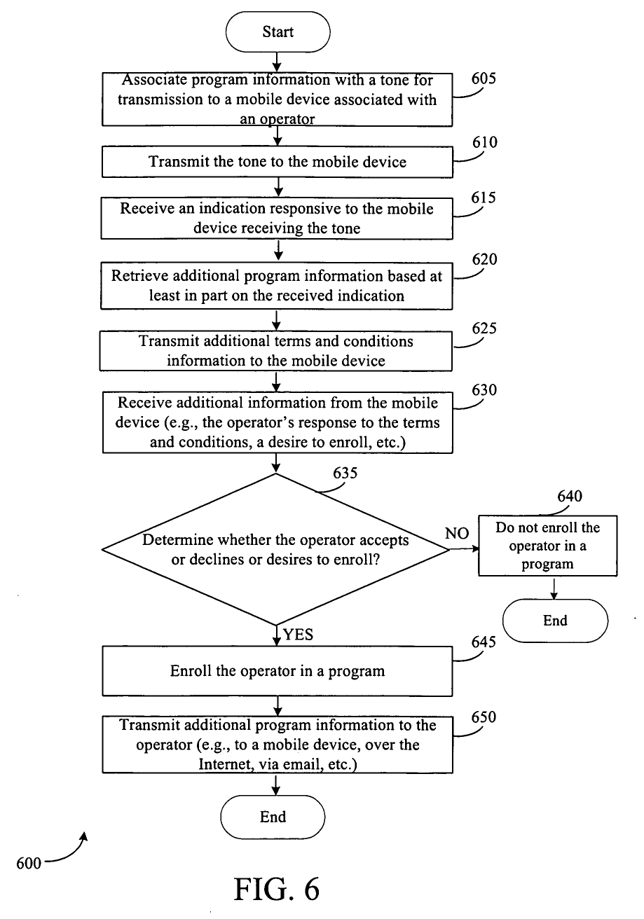

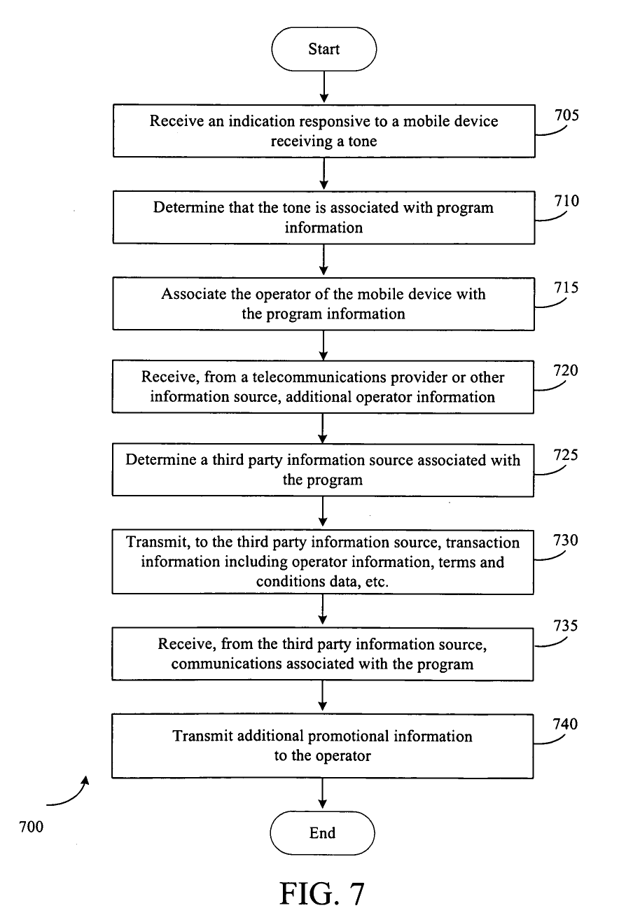

In certain embodiments of the invention, the information source 115 may include one or more software modules, such as an operating system 156 and/or a program information processing module 157. The operating system 156 may control the general operation of the information source 115 and may facilitate the execution of other software modules by the one or more processors 151, for example, the execution of the program information processing module 157. The program information processing module 157 may include computer-executable instructions that facilitate the receipt and processing of one or more requests for additional information associated with tones. For example, the program information processing module 157 may facilitate and/or control the receipt, from one or more mobile devices 110 and/or other information sources, of requests for additional information associated with tones, the processing of the received requests to access the additional information, and the communication of the additional information to the requesting entity, such as is described with reference to FIGS. 6-7, for example. Additionally, the program information processing module 157 may facilitate and/or control network communication between the information source 115 and one or more external devices, such as, a mobile device 110 and/or other information sources. Although the program information processing module 157 is illustrated as a single software component, the program information processing module 157 may include any number of software components, modules, and/or applications as desired in various embodiments of the invention.

A request for additional information associated with a tone may include one or more location or other unique identifiers that have been extracted from the tone by the mobile device 110. Additionally, the request may include an identifier of the mobile device 110. The program information processing module 157 may receive the request and process the request to extract the one or more location identifiers and/or the identifier of the mobile device 110. In other words, the received request may be transformed by the program information processing module 157 into data that is representative of the one or more location identifiers and/or the identifier of the mobile device 110. The one or more location identifiers may be utilized to access additional information associated with a tone. For example, a location identifier may be utilized to search for additional information associated with a tone that is stored in a memory 152 of the information source. In certain embodiments, a location identifier may function as a pointer to stored additional information. As another example, a location identifier may be utilized in the generation of a request for additional information that is communicated to another information source, such as a third party information source. One or more location identifiers may reference other information sources and/or memory locations associated with the other information sources. The program information processing module 157 may generate a request for additional information and communicate the request to the other information sources. The request may be processed by a host module of the other information sources and the requested additional information may be communicated to the requesting program information processing module 157. Once the additional information has been obtained by the program information processing module 157, at least a portion of the additional information may be communicated by the program information processing module 157 to the mobile device 110 via one or more suitable networks 140.

The one or more I/O interfaces 153 may facilitate communication between the information source 115 and one or more input/output devices, for example, a keyboard, mouse, display, keypad, control panel, touch screen display, remote control, microphone, disc drive, CD-ROM drive, infrared receiver, a device connected via a universal serial bus (USB) port, a device connected via a serial port, etc. In this regard, input associated with the operation of the information source 115 be received and information processed by the information source 115 may be output.

The one or more network interfaces 154 may facilitate connection of the information source 115 to one or more suitable networks 140, for example, a cellular network, a local area network, a wide area network, the Internet, a Bluetooth enabled network, a Wi-Fi network, a radio frequency network, any wired network, any wireless network, etc. In this regard, the information source 115 may receive requests for additional information and may communicate additional information associated with tones to a requesting mobile device 110. Additionally, the information source 115 may communicate with other information sources as desired. The information source 115 may utilize a wide variety of different techniques, methods, and/or systems to communicate with a mobile device 110 and/or with other information sources. For example, a web server or other specific purpose or dedicated application may facilitate communication between the information source 115 and the mobile device 110. As another example, short message service (SMS) communications may be utilized to facilitate communication between the information source 115 and the mobile device 110.

Embodiments of the invention may include information sources 115 with more or less than the components illustrated for the information source 115 illustrated in FIG. 1. The description of the information source 115 of FIG. 1 is provided by way of example only and is not intended to be limiting.

In certain embodiments of the invention, at least a portion of the additional information associated with a tone may be stored by a mobile device 110 prior to the receipt of the tone by the mobile device 110. The tone processing application 137 of the mobile device may process the received tone to extract one or more location identifiers, and the one or more extracted location identifiers may be utilized to access at least a portion of the prestored additional information. As one example, additional program information associated with a given program, such as a loyalty program, may be prestored in the memory 132 of the mobile device 110 prior to a user of the mobile device 110 visiting a retail outlet associated with the loyalty program. The additional information may be received by and prestored on the mobile device 110 utilizing a wide variety of different techniques or methods as desired. For example, the additional information may be received from an information source via one or more suitable networks, for example, a Bluetooth enabled network, a Wi-Fi network, an RFID network, cellular network, Internet connection, etc. The receipt, storage, subsequent access, and/or subsequent processing of the additional information may be managed by the tone processing application 137 in certain embodiments of invention. In this example, a user may be provided with additional program information about that is prestored on the mobile device 110, such as when encountering one or more tone transmission devices 105, for example, when shopping at a retail outlet or when watching television content.

With continued reference to FIG. 1, the system 100 may include any number of data sources 120 that are operable to communicate or otherwise provide tone data to the tone transmission device 105. In certain embodiments of the invention, a data source 120 may communicate tone data to the tone transmission device 105 via one or more suitable networks 130. Tone data may be communicated to a tone transmission device 105 in response to the receipt, from the tone transmission device 105, of a request for the tone data. Alternatively, a data source 120 may push or otherwise communicate tone data to the transmission device 105 without the tone data being requested. For example, in a merchant location, a data source 120 may push tone data associated with a product to a tone transmission device 105 situated proximate to the product. As another example, a data source 120 may include a broadcasting entity that incorporates tone data into broadcast information, such as a radio or television broadcast, that is communicated to a radio or television that functions as a tone transmission device, such as is described with reference to FIG. 3. According to one example embodiment, the data source 120 can a component of an information source 115, or otherwise associated with a same entity as an information source 115, such as a back-end processor facilitating communications associated with information carrying tones and program management.

A data source 120 may be a processor driven device or network entity that facilitates the communication tone data to another component of the system 100, for example, a tone transmission device 105 or another data source 105. The data source 120 may include any number of processors and/or processing components as desired in various embodiments of the invention. For example, the data source 120 may include any number of special purpose computers or other particular machines, application specific circuits, microcontrollers, personal computers, servers, and the like. In certain embodiments, at least a portion of the operations of the data source 120 may be controlled by computer-executed or computer-implemented instructions that are executed by one or more processors associated with the data source 120. The instructions may be embodied in one or more software components as desired in various embodiments of the invention. The execution of the instructions may form a special purpose computer or other particular machine that is operable to communicate tone data. Additionally, in certain embodiments of the invention, the operations and/or control of the data source 120 may be distributed amongst several processing components.

The data source 120 may include one or more processors 161, one or more memory devices 162, one or more input/output (I/O) interface(s) 163, and one or more network interface(s) 164. The one or more memory devices 162 may be any suitable memory devices, for example, caches, read only memory devices, random access memory devices, magnetic storage devices, databases, etc. The one or more memory devices 162 may store data, executable instructions, and/or various program modules utilized by the data source 120, for example, tone data 165 associated with tones, an operating system 166, and/or a host module 167. The stored tone data 165 may include stored data associated with a tone that is communicated to a tone transmission device 105 for output by the tone transmission device 105. For example, the stored tone data 165 may include stored digital data associated with a tone, such as, a WAV file, MP3 file, MPEG file, AIFF file, AAC file, Apple Lossless file, or other digital media file format.

In certain embodiments of the invention, the data source 120 may include one or more software modules, such as an operating system 166 and/or a host module 167. The operating system 166 may control the general operation of the data source 120 and may facilitate the execution of other software modules by the one or more processors 161, for example, the execution of the host module 167. The host module 167 may include computer-executable instructions that facilitate the communication of tone data 165 to a tone transmission device 105. For example, the host module 167 may facilitate and/or control the receipt, from a tone transmission device 105, of a request for tone data 165, the processing of the received requests to access the tone data 165, and/or the communication of tone data 165 to the tone transmission device 105. As another example, the host module 167 may facilitate the establishment of a network session or other communication with the tone transmission device 105, and the host module 167 may direct the communication or transmission of tone data 165 to the tone transmission device 105. The host module 167 may also facilitate and/or control network communication between the data source 120 and one or more other data sources. Although the host module 167 is illustrated as a single software component, the host module 167 may include any number of software components, modules, and/or applications as desired in various embodiments of the invention.

The one or more I/O interfaces 163 may facilitate communication between the data source 120 and one or more input/output devices, for example, a keyboard, mouse, display, keypad, control panel, touch screen display, remote control, microphone, disc drive, CD-ROM drive, infrared receiver, a device connected via a universal serial bus (USB) port, a device connected via a serial port, etc. In this regard, input associated with the operation of the data source 120 may be received and information processed by the data source 120 may be output.

The one or more network interfaces 164 may facilitate connection of the data source 120 to one or more suitable networks 130, for example, a local area network, a wide area network, the Internet, a cellular network, a Bluetooth enabled network, a Wi-Fi network, a radio frequency network, a television broadcast network, a television cable network, a television satellite network, a radio broadcast network, any wired network, any wireless network, etc. In this regard, the data source 120 may communicate tone data 125 to a tone transmission device 105. Additionally, the data source 120 may communicate with other data sources as desired in various embodiments of the invention. For example, a first data source 120 may receive tone data 125 from a second data source 120, and the first data source 120 may communicate the received tone data 125 to the tone transmission device 105.

Embodiments of the invention may include data sources 120 with more or less than the components illustrated for the data source 120 illustrated in FIG. 1. The description of the data source 120 of FIG. 1 is provided by way of example only and is not intended to be limiting. Additionally, in certain embodiments, a data source 120 and an information source 115 may be the same device or system.

Although FIG. 1 has been described as having specific functions performed by specific components of the system 100, various functions and/or operations of embodiments of the invention may be performed by any suitable component of the system 100. In certain embodiments, various functions and/or operations that are described as being performed by multiple components may be performed by a single component of the system 100. For example, a tone transmission device 105 may also function as an information source 115. Additionally, various operations may be completed in a distributed manner by multiple components of the system 100.

Additionally, certain components of the system 100 are described as having any number of processors or processing components. Operations may be completed by the one or more processors as desired in various embodiments of the invention. A different processor may be provided to complete or facilitate each operation of a system component, or alternatively, multiple operations may be completed or facilitated by a single processor. For example, a first processor of the mobile device 110 may facilitate the processing of a received tone to extract one or more location identifiers associated with the tone; a second processor may facilitate the storage of the extracted one or more location identifiers; a third processor may facilitate the communication of a request for additional information associated with the tone to one or more information sources; and a fourth processor may facilitate the receipt of the requested additional information from the one or more information sources. As desired, two or more of the first, second, third, and fourth processors may be the same processor. Although the example above relates to the operations of the mobile device 110, the operations of other components of the system 100 may be completed and/or facilitated in a similar manner.

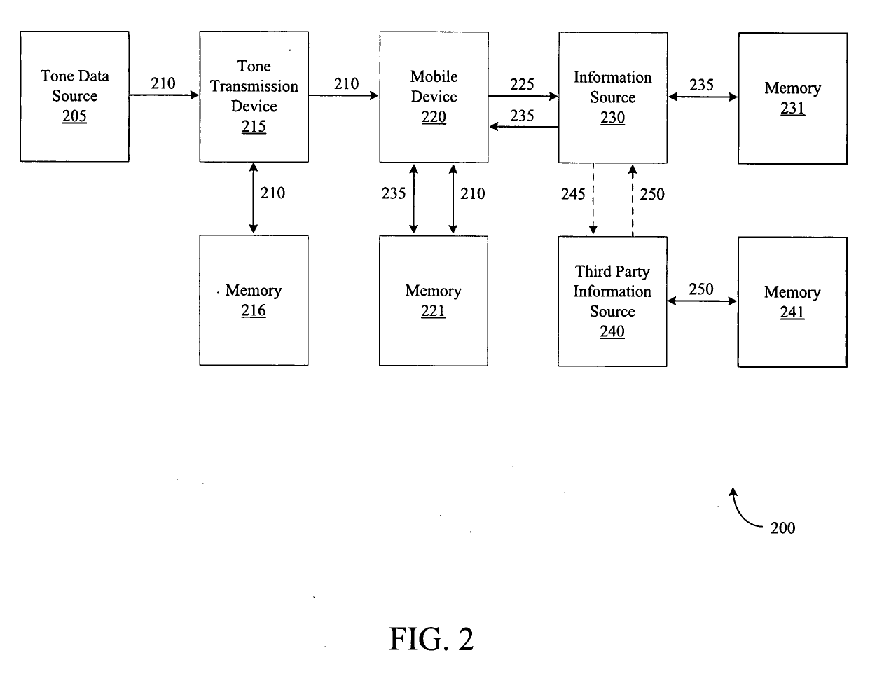

FIG. 2 is a diagram of one example data flow 200 of transmitting an information carrying tone and retrieving information associated with the tone, according to an illustrative embodiment of the invention. The data flow 200 may be applicable to a wide variety of systems utilized to communicate tones to a mobile device, including but not limited to, the system 100 illustrated in FIG. 1.

With reference to FIG. 2, a tone data source 205 may communicate an information carrying tone 210 to a tone transmission device 215. The tone transmission device 215 may include any device that is capable of communicating or outputting the tone 210 to the mobile device 220, such as any tone transmission device 105 described with reference to FIG. 1, for example. The tone data source 205 may include any device or number of devices that are capable of communicating a tone 210 or information associated with a tone to the tone transmission device 215, such as any tone data source 120 describe with reference to FIG. 1, for example. In various embodiments of the invention, the tone data source 205 may communicate a tone 210 or information associated with a tone to the tone transmission device 215 in response to a request that is received from the tone transmission device 215. In other embodiments of the invention, the tone data source 205 may proactively push the tone 210 or information associated with a tone to the tone transmission device 215 via a suitable network. In still other embodiments of the invention, the tone data source 205 may output one or more tones via one or more suitable output devices, such as one or more speakers, and the one or more tones, may be received and processed by the tone transmission device 215. The one or more tones output by the tone data source 205 may include the tone 210 and/or information associated with the tone 210.

Although FIG. 2 illustrates the tone data source 205 as communicating a tone 210 to the tone transmission device 215, in various embodiments of the invention, the tone data source 205 may communicate information associated with the tone 210 to the tone transmission device 215, and the tone transmission device 215 may utilize a portion or all of the received information to generate the tone 210 that is to be output by the tone transmission device 215.

Additionally, in various embodiments of the invention, the tone 210 and/or information associated with the tone 210 may be stored by the tone transmission device 215 in one or more suitable memory devices 216, for example, one or more caches, read only memory devices, random access memory devices, magnetic storage devices, etc. In certain embodiments, the tone 210 or information associated with the tone 210 may be accessed from the one or more memory devices 216 and output by the tone transmission device 215. Additionally, in certain embodiments, information associated with the tone 210 may be utilized by the tone transmission device 215 to generate the tone 210 to be output.

In certain embodiments of the invention, the tone 210 may be communicated from the tone transmission device 215 to the mobile device 220 by being output from one or more suitable output devices associated with the tone transmission device 215, for example, one or more speakers. In certain embodiments, the tone 210 may be output by the tone transmission device 215 in response to a request that is received from the mobile device 220. In other embodiments, the tone 210 may be proactively output by the tone transmission device 215 for reception by the mobile device 220. For example, the tone 210 may be periodically output by the tone transmission device 215 at regular time intervals, such as, every 5 seconds, every 10 seconds, every 15 seconds, etc. As another example, the tone 210 may be continuously output by the tone transmission device 215 in a loop. In other embodiments of the invention, the tone 210 may be output by the tone transmission device 215 based upon the receipt of user input to output the tone 210.

After being output by the tone transmission device 215, the tone 210 may be received by the mobile device 220. According to an aspect of the invention, the tone 210 may be received by a microphone associated with the mobile device 220. After being received by a microphone, the tone 210 may be processed through one or more filters (e.g., band pass filters) as desired and converted into digital data utilizing an analog-to-digital converter. The digital data from the tone 210 may be processed by one or more appropriate software modules and/or software applications associated with the mobile device 220, for example, the tone processing application 137 as described above with reference to FIG. 1. One or more location identifiers may be extracted from the digital data by the mobile device 220. Additionally, as desired in various embodiments of the invention, the received tone 210, digital data and/or the one or more extracted location identifiers may be stored in one or more suitable memory devices 221 associated with the mobile device 220, for example, one or more caches, read only memory devices, random access memory devices, etc.

The mobile device 220 may utilize the one or more extracted location identifiers to request additional information associated with the tone 210 from one or more information sources 230, such as is further described with reference to FIG. 5, for example. The mobile device 220 may generate a request 225 for additional information associated with the tone 210, and the mobile device 220 may communicate the request 225 to one or more information sources 230. The request 225 may include one or more of the extracted one or more location identifiers and an identifier of the mobile device 220, for example, a universal integrated circuit card (UICC) identifier, a unique device identifier (UDID), a subscriber identity module (SIM) card identifier, an international mobile subscriber identity (IMSI) number associated with the mobile device 220, or any other identifier that facilitates communication with an information source (e.g., a First Data Mobile Gateway identifier). In certain embodiments, the mobile device 220 may communicate with a central information source 230 when requesting additional information associated with a tone 210. In certain other embodiments, one or more of the location identifiers may identify one or more information sources that the mobile device 220 will communicate with in order to request additional information associated with a tone 210. In other embodiments, the mobile device 220 may initially communicate with a central information source 230 and a communication session may be passed off by the central information source 230 to another information source. In yet other embodiments, the mobile device 220 may initially communicate with a central information source 230 and the central information source 230 may establish communication sessions between the mobile device 220 and one or more other information sources. FIG. 2 illustrates the mobile device 220 communicating with a single information source 230 to request additional information associated with a tone 210; however, the mobile device 220 may communicate with any number of information sources 230, 240 as desired in other embodiments of the invention.

The request 225 for additional information associated with a tone 210 may be communicated from a mobile device 220 to an information source 230 via one or more suitable networks, for example, a cellular network, a local area network, a wide area network, the Internet, a Bluetooth network or network connection, a Wi-Fi network or network connection, a radio frequency network or network connection, any wired network, any wireless network, etc. The request 225 may be received and processed by the information source 230. The information source 230 may utilize one or more of the location identifiers to access additional information 235 associated with the tone 210 from any number of suitable memory devices 231 associated with the information source, for example, caches, read only memory devices, random access memory devices, magnetic storage devices, databases, etc., such as is further described with reference to FIGS. 6-7, for example.

Additionally, in certain embodiments of the invention, the information source 230 may communicate a request 245 for additional information associated with the tone 210 to one or more third party information sources 240, such as is further described with reference to FIG. 7, for example. The one or more third party information sources 240 may be identified by the information source 230 from one or more of the location identifiers extracted from the tone 210 by the mobile device 220. The request 245 that is communicated to the one or more third party information sources 240 may include one or more location identifiers extracted from the tone 210 and/or an identifier of the information source 240. Communication between the information source 230 and the one or more third party information sources 240 may be facilitated via one or more suitable networks, for example, a local area network, a wide area network, the Internet, a Bluetooth enabled network, a Wi-Fi network, a radio frequency network, any wired network, any wireless network, etc.

A third party information source 240 may receive and process a request 245 for additional information from the information source 230. The third party information source 240 may utilize one or more of the location identifiers to access additional information 250 associated with the tone 210 from any number of suitable memory devices 241 associated with the third party information source 240, for example, caches, read only memory devices, random access memory devices, magnetic storage devices, databases, etc. The third party information source 240 may then communicate the accessed additional information 250 to the information source 230 via the one or more suitable networks in response to the request 245. The information source 230 may receive the additional information 250 from the third party information source 240. In some embodiments, additional information 250 may be received by the information source 230 from multiple third party information sources 240, and the information source 230 may combine the received additional information 250 to generate the additional information 235 that will be communicated to the mobile device 220. Additionally, as desired in various embodiments, additional information 250 received from third party information sources 240 may be combined with additional information accessed by the information source 230. When combining information received and/or accessed from various sources, the information source 230 may extract duplicate information and/or resolve conflicts between conflicting information as desired in various embodiments. In this regard, the additional information 235 to be communicated to the mobile device 220 may be formatted for communication to the mobile device 220.

Once the additional information 235 associated with the tone 210 has been accessed and/or received by the information source 230, the information source 230 may communicate the additional information 235 to the mobile device 220 in response to the request 225 for additional information that was received from the mobile device 220. The mobile device 220 may receive the additional information 235 from the information source 230. As desired in various embodiments, the mobile device 220 may store a portion or all of the received additional information 235 in memory 221. In certain embodiments, the information source 230 may store various data associated with a request for additional information 235 that is received from the mobile device 220. For example, the information source 330 may store an indication that the mobile device 220 requested the additional information 235 and/or an indication that the additional information 235 was communicated to the mobile device 220. In this regard, tone activity for a user of the mobile device 220 may be tracked by the information source 230.

Additionally, as desired in various embodiments, the mobile device 220 may display at least a portion of the additional information to a user of the mobile device 220 via one or more suitable output devices, for example, a display. As an example, program information, such as enrollment information and/or terms and conditions, associated with the tone 210 may be displayed to the user. In certain embodiments, the mobile device 220 may utilize at least a portion of the additional information 235 to communicate with another entity. For example, the additional information 235 may include a link, such as a hyperlink, that facilitates the establishment of communication between the mobile device 220 and another entity, such as, an information source 220, 240, or another entity, system, or device associated with the tone 210. In this regard, the mobile device 210 may be utilized to access other information associated with the tone 210, for example, a web site that includes additional program information.

Many variations may be made to the data flow 200 illustrated in FIG. 2 as desired in various embodiments of the invention. The data flow 200 is not intended to be limiting, but instead is provided by way of example only as an illustrative embodiment of the invention.

Illustrative Tone Transmission Device Receiving a Broadcast Signal

FIG. 3 is a schematic diagram of an example system 300 that may facilitate the communication of information to a mobile device 315 via a tone transmission device 310 operable to communicate a broadcast signal, such as a television or radio signal, according to an illustrative embodiment of the invention. Accordingly, the system of FIG. 3 may facilitate the communication of one or more information carrying tones to a tone transmission device 310 via a broadcast signal, for example, a radio or television broadcast.

With reference to FIG. 3, the system 300 may include a broadcast entity 305, a tone transmission device 310, and a mobile device 315. The broadcast entity 305 may be operable to generate a broadcast signal or a broadcast stream that is communicated directly and/or indirectly to any number of tone transmission devices 310. Examples of broadcast companies include, but are not limited to, television networks, television broadcast companies, radio stations, etc. Examples of broadcast signals include, but are not limited to, television broadcast signals, radio broadcast signals, Internet content, etc.

The tone transmission device 310 according to this embodiment may be any suitable device that is operable to receive a broadcast signal and output at least a portion of the received broadcast signal to one or more users. Examples of tone transmission devices 310 include, but are not limited to, televisions, radios, television antennas, cable boxes, satellite television receivers, satellite radios, any combination of these devices (e.g., a television and a cable box), etc.

As desired in various embodiments of the invention, one or more tones may be included in a broadcast signal that is received by a tone transmission device 310. The tone transmission device 310 may receive the one or more tones in a broadcast signal and output the one or more received tones with the broadcast signal. The one or more received tones may be communicated by the tone transmission device 310 to a mobile device 315. For example, one or more suitable output devices 320, such as one or more speakers associated with the tone transmission device 310, may be utilized to output the one or more tones. The one or more tones may then be received by one or more input devices 325, such as a microphone, associated with the mobile device 315. In this regard, one or more tones included in a broadcast signal may be communicated to a mobile device 325, and the mobile device 325 may process the one or more received tones to extract one or more location identifiers that are utilized to gather additional information associated with the one or more tones, such as is described with reference to FIGS. 6-7, for example.

In certain embodiments of the invention, a broadcast entity 305 may communicate a broadcast signal directly to a tone transmission device 310. For example, a broadcast entity 305 may utilize one or more transmission towers 330 to transmit or otherwise communicate audio and/or video signals that may be directly received by the tone transmission device 310 and/or equipment associated with the tone transmission device 310, for example, an antenna associated with the tone transmission device 310.

In other embodiments of the invention, a broadcast entity 305 may communicate a broadcast signal to one or more intermediary systems and/or service providers 335, 340, 345, 350. The one or more intermediary systems and/or service providers 335, 340, 345, 350 may receive the broadcast signal from the broadcast entity 305 and communicate the broadcast signal to the tone transmission device 310. A wide variety of techniques and/or systems may be utilized as desired to communicate the broadcast signal from the broadcast entity 305 to an intermediary system or service provider 335, 340, 345, 350. For example, the broadcast entity 305 may communicate a broadcast signal to an intermediary system 335, 340, 345, 350 via one or more satellites 355 and/or satellite communications systems, such as, the EchoStar Technologies™ satellite communications system. As another example, the broadcast entity 305 may communicate a broadcast signal to an intermediary system 335, 340, 345, 350 via one or more suitable networks 360, such as, a fiber optic network, a cable network, an IP television network, the Internet, a wide area network, any suitable wired network, and/or any suitable wireless network. As yet another example, the broadcast entity 305 may utilize one or more transmission towers 330 to transmit or otherwise communicate the broadcast signal to an intermediary system 335, 340, 345, 350.

Any number of intermediary systems and/or service providers 335, 340, 345, 350 may be utilized as desired in various embodiments of the invention. An intermediary system 335, 340, 345, 350 may receive a broadcast signal from a broadcast entity 305 or from another intermediary system 335, 340, 345, 350 as desired in various embodiments. The intermediary system 335, 340, 345, 350 may then communicate the received broadcast signal to the tone transmission device 310 or to another intermediary system 335, 340, 345, 350. For purposes describing example intermediary systems 335, 340, 345, 350, the intermediary systems 335, 340, 345, 350 will be described as receiving a broadcast signal from a broadcast entity 305 and communicating the received broadcast signal to a tone transmission device 310. Examples of intermediary systems and/or service providers include, but are not limited to, a satellite provider 335, a cable provider 340, a local provider 345, and an internet service provider 350.

A satellite provider 335 may receive a broadcast signal from the broadcast entity 305 and transmit or otherwise communicate at least a portion of the broadcast signal to the tone transmission device 310 via one or more suitable satellites 365 and/or satellite communications systems, for example, a satellite television communications system or a satellite radio communications system. Similarly, a cable provider 340 may receive a broadcast signal from the broadcast entity 305 and transmit or otherwise communicate at least a portion of the broadcast signal to the tone transmission device 310 via one or more suitable cable networks 370. Similarly, a local provider 345 may receive a broadcast signal from the broadcast entity 305 and transmit or otherwise communicate at least a portion of the broadcast signal to the tone transmission device 310 via one or more suitable transmission towers 375. Similarly, an internet service provider (ISP) 350 may receive a broadcast signal from the broadcast entity 305 and transmit or otherwise communicate at least a portion of the broadcast signal to the tone transmission device 310 via one or more suitable Internet connections, for example, a wide area network, etc.

As desired in various embodiments of the invention, one or more information carrying tones may be incorporated into or included in the broadcast signal that is received by the tone transmission device 310. The one or more tones may be incorporated into the broadcast signal by the broadcast entity 305 and/or by one or more intermediary systems 335, 340, 345, 350. For example, the broadcast entity 305 may insert, layer, embed, or otherwise incorporate one or more tones into a broadcast stream prior to or during the communication of the broadcast stream to a tone transmission device 310 or to an intermediary system 335, 340, 345, 350. The one or more tones may relate to, for example, marketing programs or services that are advertised via the broadcast stream (e.g., television or radio advertisement), programs included in the broadcast stream (e.g., television shows, movies, radio shows), etc. The incorporation of a tone into the broadcast stream may include the insertion of the tone into the broadcast stream utilizing a wide variety of different techniques and/or methods, for example, modulation, the insertion of a digital packet of information that includes the tone, the transmission of the tone in a separate channel or carrier signal, etc. Additionally, as desired in various embodiments of the invention, a tone may be incorporated into the broadcast stream as either an analog signal or as digital information.

With continued reference to FIG. 3, the system 300 may include one or more tone data sources 385. Each tone data source 385 may be operable to communicate or otherwise provide one or more tones and/or data associated with the generation of one or more tones to the broadcast entity 305 and/or an intermediary system 335, 340, 345, 350. In certain embodiments of the invention, a tone data source 385 may communicate tones and/or tone data to the broadcast entity 305 and/or an intermediary system 335, 340, 345, 350 via one or more suitable networks 360, for example, a local area network, a wide area network, the Internet, a telephone network, a broadcast network, a cellular network, any wired network, any wireless network, etc. In this regard, the broadcast entity 305 and/or an intermediary system 335, 340, 345, 350 may receive tones that are inserted into a broadcast signal and/or information that may be utilized to generate tones that are inserted into a broadcast signal. Tones and/or tone data may be communicated to the broadcast entity 305 and/or an intermediary system 335, 340, 345, 350 in response to the receipt of a request for the tones and/or tone data. Alternatively, a data source 385 may push or otherwise communicate tones and/or tone data to the broadcast entity 305 and/or an intermediary system 335, 340, 345, 350 without the tones and/or tone data being requested. Each tone data source 385 may be a suitable processor driven device with components that are similar to the tone data sources 120 described above with reference to FIG. 1 and the tone data sources 210 described above with reference to FIG. 2. According to one example embodiment, the data source 385 can a component of an information source, such as is described with reference to FIGS. 1-2, or otherwise associated with a same entity as an information source, such as a back-end processor facilitating communications associated with information carrying tones and program management.

Once the broadcast stream is received by the tone transmission device 310, the tone transmission device 310 may process and output at least a portion of the received broadcast stream via one or more suitable output devices 320, for example, one or more displays and/or speakers associated with the tone transmission device 310. A wide variety of tone transmission devices 310 may be utilized as desired in various embodiments of the invention, for example, a radio, television, projector, computer, etc. In certain embodiments of the invention, the broadcast stream may be processed and output in real time or near real time as it is received by the tone transmission device 310. In other embodiments of the invention, at least a portion of the broadcast stream may be stored in one or more suitable memory devices associated with the tone transmission device 310 (e.g., a digital video recorder), and the stored portion of the broadcast stream may be accessed from memory, processed, and/or output at a subsequent point in time.

During the outputting of the broadcast stream by the tone transmission device 310, one or more tones included in the broadcast stream may be output. A mobile device 315 that is within a predetermined distance or range “d” from the tone transmission device 310 may be utilized to receive the one or more tones that are output. The mobile device 315 may process one or more received tones in order to extract one or more location identifiers that are utilized to request and receive additional information associated with the one or more tones. In this regard, additional information associated with a broadcast stream, for example, program information, such as enrollment information and/or terms and conditions, may be received by a mobile device 315 and presented to a user of the mobile device.

Illustrative Information Carrying Tone

FIG. 4 illustrates a block diagram of data that may be included in an example information carrying tone, according to an illustrative embodiment of the invention.

With reference to FIG. 4, an information carrying tone 400 may include a header portion 405, a data portion 410, and/or a check sum portion 415, according to one embodiment. The header portion 405 may include, for example, information that identifies the tone 400 and the information and/or data that is included in the tone 400. The data portion 410 may include a data payload, for example, one or more location identifiers, that may be extracted from the tone 400 by a mobile device. Any number of location identifiers may be included in the data portion 410 as desired in various embodiments of the invention. Additionally, content identifiers 420 and/or information source identifiers 425 may be included in the data portion 410 as desired. A content identifier 420 may identify, reference, or point to a memory location or block of memory at which additional information associated with the tone 400 is stored at an information source. An information source identifier 425 may identify, reference, or point to an information source at which additional information associated with the tone 400 is stored. Any other data may be included in the data portion 410 of the tone 400, according various embodiments. The check sum portion 415 may include suitable information and/or data that may be utilized by a receiving mobile device to verify that the tone 400 has been properly received.

The tone 400 described with reference to FIG. 4 illustrates one example of the information or data that may be included in a tone 400 that is utilized in various embodiments of the invention, as further described herein. A wide variety of other information and/or information formats may be utilized to form a tone as desired in various embodiments of the invention. The tone 400 of FIG. 4 is provided by way of example only and is not intended to be limiting.

Additionally, when a tone is output to a mobile device by a tone transmission device, the tone may be output as an analog signal. In certain embodiments of the invention, analog data for a tone may be received or accessed from memory by a tone transmission device, and the analog data may be output for receipt by a mobile device. In other embodiments of the invention, digital data for a tone may be received or accessed from memory by a tone transmission device, and the digital data may be transformed into analog data and output for receipt by a mobile device. A tone may be output utilizing a wide variety of signals as desired in various embodiments of the invention. For example, in certain embodiments, the information carried in a tone may be added to a base or carrier signal by modulating the base signal.

Receiving an Information Carrying Tone Associated with a Program on a Mobile Device

FIG. 5 is a flowchart of one example method 500 for receiving and responding to information carrying tones associated with a program, in accordance with various embodiments of the invention. The method 500 may provide for receiving information carrying tones at a mobile device, processing the tones to extract location or other unique identifiers that may be identify the program and/or be associated with the additional program information, such as terms and conditions information, enrollment information, or other program associated information. In addition, the method 500 may further provide for receiving and/or displaying additional program information, and transmitting information to another entity, such as transmitting an indication of whether the mobile device operator (also referred to interchangeably herein as a “user” or “mobile device user”) accepts program terms and conditions or otherwise wishes to participate in a respective program.

The method 500 may begin at block 505. At block 505, a mobile device may receive an information carrying tone that includes a location or other unique identifier associated with program information. The mobile device may be any mobile device, such as the mobile device 110 described with reference to FIG. 1. The location or other unique identifier may be any identifiers, such as the location identifier 900 described with reference to FIG. 4.

The mobile device may receive the information carrying tone from any tone transmission device, such as a tone transmission device 105 described with reference to FIG. 1. Example tone transmission devices may include a television, a radio, or a standalone tone transmission device. For example, in one embodiment, while viewing television content, the signal broadcast may include a tone having a location or other unique identifier that is played by a speaker of the television, such as is further described with reference to FIG. 3. The tone may be broadcast in the television content in association with an advertisement or with other marketing information to encourage the viewer's participation. The television content may optionally also display a symbol, play a sound, or other indicia indicating that a tone is being broadcasted. If the user is interested in participating and/or receiving additional information associated with the broadcasted content, the user may activate a mobile device to receive the tone. According to one embodiment, the mobile device may include programming instructions, such as the tone processing application 137 described with reference to FIG. 1, operable to receive a command to receive the tone being communicated. For example, the tone processing application may activate a microphone or other audio input device to capture the tone and store the tone and/or extracted a location or other unique identifier in memory.

In other embodiments, an information carrying tone may be transmitted via a radio signal through a radio to a listener, whereby the listener can activate a mobile device to receive the tone, such as is also described with reference to FIG. 3. In yet other embodiments, the tone may be transmitted from a standalone tone transmission device, such as one associated with an advertisement display at a retail store or an advertisement poster or billboard elsewhere. In these embodiments, the advertisement display may indicate that additional program information may be received and/or program terms and conditions may be accepted using a mobile device. Like the other embodiments, if an observer of the advertisement display is interested in participating or receiving additional information, the observer may activate a mobile device to receive the tone and associated a location or other unique identifier.

Following block 505 is block 510, in which the mobile device may perform processing on the information carrying tone received to extract location or other unique identifier carried thereon. For example, in one embodiment, the mobile device may filter the tone, convert the tone to digital data, and may optionally store data converted from the tone. For example, as part of the processing performed at block 510, programming instructions, such as the tone processing application, and associated mobile device hardware, such as one or more band pass filters and one or more analog-to-digital converters, can process the tone to identify and extract digital one or more location or other unique identifiers. As described above, the location or other unique identifier may be associated with additional program information, which may already be stored on the mobile device or may be retrieved from an information source.

Additional processing, as further described herein, may be performed on the tone received by the mobile device, at this or any other point of the method 500.

Following block 510 is block 515, in which the tone data extracted from the information carrying tone may be stored in a memory of the mobile device. In example embodiments, the location or other unique identifier may be stored in the memory only temporarily, such as when it may be transmitted to retrieve other information from another information source, or may be further operated on by the processor of the mobile device, such as to retrieve additional information stored in or otherwise accessible by the mobile device, to display information associated with the identifier, and/or to request information from the operator of the mobile device. Though, in other embodiments, the location or other unique identifier may be permanently stored in the memory, or stored in the memory for a given period of time. In yet other embodiments, the location or other unique identifier may be immediately transmitted to another entity, such as an information source, and storage in memory for any substantial period of time may be unnecessary.

Following block 515 is block 520, in which the mobile device may transmit to an information source an indication responsive to the mobile device receiving the information carrying tone. The information source to which the indication can be transmitted may include, but is not limited to, a central information source, such as a back-end processor, or a third party information source, such as a merchant, service provider, or marketer associated with the program. This transmission may be performed to inform the information source that the mobile device received the tone, and may optionally include a location or other unique identifier extracted from the tone, such as may be extracted at block 510.

In other embodiments, however, the initial transmission from the mobile device to the information source may serve both to indicate that the mobile device received the tone and that the operator of the mobile device wishes to enroll or otherwise participate in the associated program. For example, in one embodiment, when viewing a television broadcast, program information and terms and conditions may be displayed on the screen and/or described in the audio portion of the content. As part of the program information, the instructions may indicate that if a viewer wishes to participate and enroll themselves in the program being advertised, the viewer may activate their mobile device to receive a tone, the receipt of which will enroll them in the program. Thus, the information source managing the program needs only to be notified that the mobile device operator received the tone and which tone was received. Transmitting an indication that the mobile device received a tone and the location or other unique identifier in block 520 provides sufficient information to enroll a mobile device operator under these conditions.

Though in other embodiments, additional information may be needed before an operator can decide whether to participate in a marketing program. For example, a television broadcast may indicate to viewers that additional program information, including program terms and conditions and/or enrollment information, may be retrieved by activating a mobile device to receive the tone. Upon receiving the tone, and extracting the location or other unique identifier, the mobile device may transmit an indication that the user received the tone and the location or other unique identifier extracted from the tone. This transmission may serve to request additional information associated with the identifier (e.g., program terms and conditions or other enrollment information) from the information source. In another embodiment, a request for additional information may be transmitted separately from the indication.

Moreover, in one embodiment, the indication transmitted at block 520 may also include an identifier of the mobile device and/or the operator of the mobile device. The identifier of the mobile device may be used by the information source to associate subsequent information transmitted to/from the mobile device, as well as to identify the operator to a third party information source, such as a merchant, marketer, or service provider.

According to another embodiment, the tone processing application may be configured to extract pre-established information that may be used to identify the operator, such as may be stored in a user profile, such as the user profile 138 described with reference to FIG. 1. For example, the user profile may include name, account number, email address, username, area code, zip code, phone number, mobile device number information that may be requested by and/or transmitted to an information source. In yet another embodiment, the tone processing application may be configured to extract information resident with the mobile device, such as a mobile device number, UICC identifier, SIM card identifier, or IMSI number, which may also be transmitted to an information source to identify the operator.

According to yet another embodiment, the tone processing application and/or the mobile device may not be configured to request input from the operator until the mobile device receives a request from an information source. For example, a request for information may be transmitted after an information source is notified that the mobile device received a tone and respective location identifier, as further described below.

Following block 520 is block 525, in which additional information related to the location or other unique identifier transmitted by the tone may optionally be received and/or displayed on the mobile device. In embodiments in which additional information may be requested (or automatically transmitted) after initially receiving the information carrying tone, such as is described in embodiments occurring at block 520, the mobile device may receive additional information from an information source.

According to various embodiments, additional program information may be received by the mobile device via cellular communication, such as an SMS message, email, audio message, or a website address, for example. Upon receiving the additional program information, the mobile device and its tone processing application may optionally perform additional processing on the information prior to display to the operator.

In other embodiments, however, the mobile device may already have additional program information stored in memory, such as information which may have bee previously stored in memory of the mobile device when downloading a software application or associated application supplements specific to the program associated with the information carrying tone or the entity associated with the program. Information already stored in memory may be displayed separately or as a supplement to additional information received from an information source.

According to one embodiment, the mobile device may format and output the additional program information to the operator. For example, after any processing that may be required is performed, the additional information may be output in text form to a display screen or as an audio message may played over a speaker.

According to another embodiment, however, the additional information may be presented by a website or other Internet-based application accessible over a cellular network (or other network, such as Wi-Fi network), such that when displaying additional information, the mobile device accesses a website providing the information. The website address or other identifier may be provided to the mobile device in response to transmitting the indication and/or request for information to an information source at block 520. In yet other embodiments, however, the location or other unique identifier transmitted with the tone and extracted by the mobile device at blocks 505 and 510 may also include website address information, eliminating the need to transmit a request for additional program information from an information source. Providing the information via a website also allows dynamically delivering additional content, based on the operator's access or selection within the website (e.g., hyperlinks), expanding the volume of information that may be displayed to the operator. However, some mobile devices may not be operable to access Internet-based applications; thus, text and/or audio data transmitted to the mobile device, as described above, permit additional program information be presented to the user.

Additional information transmitted and/or displayed to the user may include, but is not limited to, program information describing additional details about the program, program terms and conditions details, enrollment information, product information, service information, policy information, associated legal terms, requests for input from the operator, such as is described with reference to block 510, or any other information that may facilitate describing a program, its associated terms and conditions, and enrollment therein.

Following block 525 is block 530, in which operator input may optionally be requested by the mobile device. One aim of these example systems and methods is to determine whether an individual wishes to participate in a program, and thus provide a means for obtaining a person's acceptance to participate and of the associated program terms and conditions. According to one embodiment, the request for the operator's input may be transmitted by an information source to the mobile device. Though, in another embodiment, the mobile device may have stored thereon information that can be retrieved to generate and present a request for the operator's input, such as may be accomplished by the tone processing application, for example.

One manner to determine an individual's acceptance or agreement to participate can include requesting an affirmative response from an operator upon viewing complete terms and conditions or other program enrollment information. Accordingly, at block 530, the mobile device may display a request for the operator's response to program information presented to the operator, such as may occur in block 525. For example, an “Accept” or “Decline” button may be displayed on a webpage after scrolling through the program information. In other examples, the operator may be requested to select “1” if accept, “2” if decline, or it may be explained that by responding to the program information (e.g., transmitting a return message, etc.) the operator indicates acceptance to enroll in the program. Any other suitable techniques for capturing the operator's response indicating an acceptance or declination to enroll in the program may be used.

In other embodiments, at block 530 the operator may be requested to provide information other than indicating whether the operator accepts. For example, the operator may be prompted to provide information such as, but is not limited to, name, date of birth, social security number, street address, city, state, zip code, telephone number(s), email address, age information, preferences, password information, account information, billing information, product information, and the like.

Following block 530 is block 535, in which the mobile device may optionally transmit the operator's input to an information source. For example, in one embodiment, upon receiving the operator's input to the mobile device, such as may occur at block 530, the mobile device transmits the operator's input to the information source. The information transmitted to the information source may be any information input by the operator, such as an acceptance (or declination) to program terms and conditions, or additional information, such as may be gathered by the tone processing application from information already stored in memory on the device or input by the operator. In one embodiment, the location or other unique identifier, an identifier of the mobile device, and/or an identifier of the operator, may be included in the message transmitted to the information source, permitting the information source to associate the response with the operator and/or the program identified.

Following block 535 is block 540, in which the mobile device may optionally receive an indication of the operator's status with regard to the program associated with the location or other unique identifier. For example, in one embodiment, if the operator accepts the program terms and conditions, indicating a desire to participate and/or requesting enrollment in the program, at some later time, an information source may transmit a message to the mobile device indicating that the operator has been enrolled in the program. In some embodiments, the message may include further program information, such as, but not limited to, account information, additional program terms, product information, services information, or promotional information.

In other embodiments, the mobile device may receive information requesting yet additional information to be entered or otherwise provided by the operator even after having agreed to participate in the program. For example, additional information may be needed from the operator to process the operator's enrollment in the program, such as, but not limited to, name, date of birth, social security number, street address, city, state, zip code, telephone number(s), email address, age information, preferences, password information, account information, and billing information.

In yet other embodiments, the mobile device may receive different promotional information, such as if the operator declined to participate in the initial program associated with the location or other unique identifier. For example, an information source may transmit information associated with another program, which may or may not be related to the initial program, or may alter the terms of the initial program, such as to provide greater enticement for the operator to participate in the program. In other embodiments, different promotional information may be transmitted to the mobile irrespective of whether the operator agreed to participate in the promotion. For example, an information source may identify the operator as a good target for mobile device-based promotions or identify the mobile device as a preferred or otherwise effective channel for contacting the operator, and thus communicate new information to the operator using the mobile device.

The method 500 may end after block 540, having received program information on a mobile device based on an initial information carrying tone transmitted to the mobile device and optionally including subsequent communications between the mobile device and one or more information sources to capture whether the operator accepts or declines the program terms and conditions or enrollment information and/or to gather additional information from the operator.

Information Source Processing Associated with Tones Associated with a Program

FIG. 6 is a flowchart of one example method 600 for communicating program information with a mobile device, which may be initiated by communicating one or more information carrying tones, in accordance with various embodiments of the invention. The method 600 may provide for associating tones with program information, such as program terms and conditions information or enrollment information, transmitting information carrying tones to a mobile device, and subsequent communications with the mobile device based on the mobile device having received a given tone. Accordingly, an information source, such as a central information source like a back-end processor, or any third party information source, such as a merchant, marketer, service provider, financial institution, and the like, can interact with a potential customer via their mobile device to enroll them in a marketing program, as described with reference to FIG. 5. Moreover, by initially transmitting a tone carrying information that facilitates these subsequent communications to a potential customer's mobile device, these potential customers may be conveniently accessed with little effort by the entity associated with the program and with little inconveniences to the potential customer.

The method 600 may begin at block 605. At block 605, an information source may associate program information, such as program terms and conditions, program enrollment information, or any other program details, with one or more tones to be transmitted to one or more mobile devices via a tone transmission device. A location identifier carried by the information carrying tones can be used to identify the program information associated therewith.

According to one embodiment, an information source, such as a central information source, may receive program information from another entity, such as any third party entity associated with the program being offered. The central information source may then store this program information in memory, such as in one or more databases or other data storage devices, and associate one or more tones with the program information. A location or other unique identifier may be utilized to identify program information stored in a memory at the central information source (and/or to additional program information stored at a third party information source).

Following block 605 is block 610, in which one or more information carrying tones carrying the location or other unique identifier, are transmitted to a mobile device. Tones may be transmitted to a mobile device using any tone transmission device, such as atone transmission device 105 described with reference to FIG. 1. Upon receiving the information carrying tone, the mobile device and its tone processing application can extract an identifier, request input from the operator, perform additional processing, and the like, as is described with reference to FIG. 5.

Following block 610 is block 615, in which an information source receives at least an indication responsive to the mobile device receiving the information carrying tone transmitted at block 610. As described above, the indication may be received to inform the information source that the mobile device received the tone, and may optionally include a location or other unique identifier extracted from the tone. In other embodiments, also described above, the initial receipt of the indication from the mobile device may serve both to indicate that the mobile device received the tone and that the operator of the mobile device wishes to enroll or otherwise participate in the associated program. However, in other embodiments, additional information may be needed before an operator can decide whether to participate in a marketing program; thus, the initial indication received from the mobile device may serve to request additional program information associated with the location or other unique identifier. According to one embodiment, a request for additional information may be transmitted separately from the indication.

In one example embodiment, the indication received may include one or more of a location identifier extracted from the tone, an identifier of the mobile device, or an identifier of the operator of the mobile device. The identifier of the mobile device and/or operator may be used by the information source to associate subsequent information transmitted to/from the mobile device, as well as to identify the operator to one or more third party information sources.

According to other embodiments, multiple messages may be received from the mobile device at block 615. For example, one or more separate messages may be transmitted from the mobile device identifying the location or other unique identifier, the mobile device, the operator, and/or any other additional information. In another example, one or more separate message may be transmitted form the mobile device requesting additional information and/or promotion validation, activation, or other processing.

Moreover, according to one embodiment, the information source operable to receive the indication at block 615 can be the same information source, or one associated therewith, that associates the program information to the tone, such as the central information source described at block 605. For example, the central information source may be responsible for generating the program information, storing the program information, associating program information to one or more tones, and subsequently processing program information upon transmitting a tone to a mobile device, such as to determine whether the operator accepts or declines the program terms and conditions. Though, in other embodiments, the information source operable to receive the indication at block 615 may be a different information source from the information source that associates the program information to the tone at block 605. For example, a third party information source, such as a different back-end processor or a merchant, marketer, or service provider, may participate in processing program enrollment for an operator, instead of or in addition to the central information source. In yet other embodiments, a central information source and one or more third party information sources may participate together, exchanging information therebetween, to retrieve and/or transmit additional program information, as described in detail with reference to FIG. 7.

Following block 615 is block 620, in which the information source may optionally retrieve additional program information responsive at least in part to receiving the indication as at block 615, according to one example embodiment. In one embodiment, additional program information may be retrieved and transmitted to the mobile device (or to the operator via any other means) automatically in response to receiving the indication at block 615. Though in other embodiments, additional program information may be retrieved and transmitted only when requested by the mobile device or operator.

According to one embodiment, additional program information can be stored by the central information source. In another embodiment, instead of or in addition to retrieving information from the central information source, the central information source may request additional program information from one or more third party information sources, such as is described with reference to FIG. 7 below.

The location identifier, or other program information associated with the information carrying tone, may be used to retrieve additional program information from memory or from a third party information source. For example, according to one embodiment, a location identifier can identify the respective program and associated program information stored in a memory. In another embodiment, a unique identifier identifying one or more third party information sources associated with the program may be received at block 615 and used to retrieve additional program information from one or more third parties.

In some embodiments, the information source may perform processing on the additional information retrieved prior to transmitting to the mobile device or operator. Additional processing steps may include, but are not limited to, formatting, generating text or audio messages from data elements and predefined messages, generating user interface for display, sorting, filtering, and the like.

In example embodiments, the additional information retrieved may include, but is not limited to, program information describing additional details about the program, program terms and conditions details, enrollment information, product information, service information, policy information, associated legal terms, requests for input from the operator, or any other information that may facilitate describing a program, its associated terms and conditions, and enrollment therein.

Following block 620 is block 625, in which the information source may optionally transmit additional program information retrieved at block 620 to the operator. According to one example, the additional program information may be transmitted to the operator's mobile device for to be displayed or otherwise output to the operator. For example, the additional program information may be transmitted in text or graphic form for output to a display, or in audio form for playing over a speaker. In other embodiments, the additional program information may be transmitted to the mobile device as a website address to a website or other Internet-based application accessible over a cellular network (or other network, such as Wi-Fi network), permitting additional program information to be displayed on the mobile device upon accessing a website providing the information. Moreover, while a single message is being described herein, additional program information transmitted between information source and the mobile device (in this or any other communication described) may be transmitted in multiple messages.

In one embodiment, the additional program information may be transmitted by a central information source, such as the information source receiving the indication at block 615. Though in other embodiments, the additional program information may be transmitted by another information source, such as a third party information source associated with the program, such as is described with reference to FIG. 7 below.

Following block 625 is block 630, in which an information source may optionally receive additional information from the mobile device, according to one embodiment. For example, the mobile device operator may provide additional information to the information source, for storing in memory and/or transmitting to a third party information source. According to one embodiment, the additional information may be an operator response to program information previously presented to the operator. For example, the operator may input to the mobile device via a user interface whether he or she accepts program terms and conditions, or agrees to participate or otherwise be enrolled in the program. After an operator provides an input, and after any processing may optionally be performed, the operator's response can be received from the mobile device by an information source. In other embodiments, the additional information received at block 630 may include, but is not limited to, name, date of birth, social security number, street address, city, state, zip code, telephone number(s), email address, age information, preferences, password information, account information, billing information, and product information.

Following block 630 is block 635, in which it is determined whether the operator of the mobile device wishes to participate in the program associated with the tone, such as by receiving an acceptance or declination of program terms and conditions previously presented to the operator or an express request to be enrolled or otherwise participate in the program.

According to one example, as described above, merely receiving the indication that the mobile device received the tone at block 615 may be enough information for the information source to determine that the operator agrees to participate in the program. In another example, the indication received at block 615 may include or be accompanied by an additional operator response indicating whether the operator wishes to participate in the program. In yet another example, an additional message received at block 630 from the mobile device may include an operator response affirmatively indicating whether the operator wishes to participate in the program. In yet another example, simply receiving an additional message at block 630 may indicate that the operator wishes to participate in the program, such as may occur when the operator is presented with an option stating that by transmitting this response or responding to this communication the operator agrees to participate in the program and abide by its associated terms and conditions.

A response may be embodied in any form, including, but not limited to, selection of one of multiple choices (e.g., yes/no, agree/disagree, participate/do not participate, please/no thank you, enroll/do not enroll, etc.), a free form text response, a selection of one of multiple hyperlinks, an audio message, and the like.

To determine whether the operator wishes to participate in the program, the information source may optionally perform additional processing of the information received from the mobile device. For example, the information source may parse one or more messages to identify one or more data elements, including, but not limited to, a location identifier, operator identifier, mobile device identifier, response indicator, program information, operator information, or any other information which may be transmitted by mobile device and expected by information source processing application.

In one example, the information source may determine whether the a response indicator indicates that the user wishes to participate in the program (e.g., includes yes, agree, participate, please, enroll, etc.), or that the user does not wish to participate in the program (e.g., includes no, disagree, do not participate, no thank you, do not enroll, etc.). In another example, the information source may determine whether the user wishes to participate based upon a message element, such as header information, message type, subject information, and the like, such that an acceptance will have an element of a first type and a declination will have an element of a second type. In yet another example, the information source may determine whether the operator wishes to participate based upon where or how the message is received from the mobile device. For example, an operator providing a first response type (e.g., acceptance) may send a message to a first destination (e.g., phone number, web address, email address, voicemail mailbox) and or another response type (e.g., declination, more information, etc.) may send a message to a second destination, such that the receipt at a given destination may indicate whether the operator wishes to participate in the program. Any other suitable means for receiving communications, such as electronic, text, audio, or graphic communications, and extracting information from the communication received may be used as desired according to various embodiments.

According to one embodiment, the determination of whether the operator wishes to participate in the program may be determined by a central information source, such as the information source receiving the indication at block 615 or the additional message at block 630. Though in other embodiments, the determination may be performed by another information source, such as a third party information source associated with the program, as is described in detail with reference to FIG. 7 below.

If it is determined at block 635 that the operator does not wish to participate, block 640 follows. At block 640, the information source will perform processing such that the operator is not enrolled in the program. According to one embodiment, this step may not include any affirmative action on the part of an information source, such that not enrolling the operator in a program or not transmitting additional information to a third party information source is enough.

Though, in other embodiments, a central information source, or a third party information source, may affirmatively update one or more entries associated with the operator and/or the respective program indicating that the operator declines the offer to participate in the program or has not agreed to program terms and conditions, for example. Performing an update or change in status may be beneficial for subsequent marketing activities. For example, the methods by which the operator are contacted or the types of information used when contacting the operator may be altered based on past experiences with the operator. Moreover, expressly indicating that the operator has declined to participate may trigger additional communications with the operator, such as follow-up messages, surveys, altered program terms and conditions, and the like.

According to one embodiment, a notice of the operator's status, such as indicating that the operator has not been enrolled, may be transmitted to the operator as a result of not enrolling the operator.

If it is determined at block 635 that the operator does wish to participate in the program, blocks 645 and 650 follow. At block 645, the information source may perform processing to enroll the operator in the respective program. According to one embodiment, actual enrollment of the operator may be performed by a central information source, such as if the central information source is managing the program activities. For example, the central information source may update one or more entries associated with the operator indicating their enrollment in the program and their acceptance to program terms and conditions. In another embodiment, a central information source may effectively enroll the operator by transmitting a message to a third party information source for the third party information source to perform associated data updates and status changes, such as is described in detail with reference to FIG. 7 below.

Following block 645 is block 650, in which additional program information may optionally be transmitted to the mobile device upon enrolling the operator in the program. According to one embodiment, additional program information may include a notice of the operator's status, such as indicating that the operator has been enrolled. According to another embodiment, additional program information may include, but is not limited to, account information, additional program terms, product information, services information, or promotional information. In other embodiments, an information source may transmit a request for yet additional information to be entered or otherwise provided by the operator even after having agreed to participate in the program. In yet other embodiments, the mobile device may receive different promotional information, such as supplemental promotions, related programs, and/or unrelated programs. Having agreed to participate in a program that was initially transmitted by a tone to the operator's mobile device, the information source may identify the operator as a good target for mobile device-based programs or identify the mobile device as a preferred or otherwise effective channel for contacting the operator, and thus communicate new information to the operator using the mobile device.

The method 600 may end after block 650, having communicated program information with a mobile device based on an initial information carrying tone transmitted to the mobile device, capturing whether the operator accepts or declines program terms and conditions or otherwise wishes to enroll, enrolling the operator if accepted, and optionally transmitting additional program information to the operator.

FIG. 7 is a flowchart of one example method 700 in which a central information source and one or more third party information sources participate together to communicate program information to and facilitate program enrollment of a mobile device operator, according to one embodiment. The method 700 may provide integration between a central information source and one or more third party information sources and distribute roles and responsibilities therebetween. By distributing some functions to one or more third party information sources, the amount of data and transaction processing managed by a central information source can be greatly reduced. In addition, by including the third party information sources, such as those sponsoring or otherwise associated with the program, additional rules and business logic may be implemented by each third party information source that is particular to that entity and/or more specific to the respective program, without requiring a complex integration and/or processing overhead at a central information. It may be beneficial to limit the amount of information provided to and/or processed by a central information source, such as to maintain company trade secrets, business advantages, marketing information, and the like. Accordingly, the method 700 provides one example embodiment of limiting the amount of information and/or transaction processing performed by a central information source by integrating with one or more third party information sources.

The method 700 may begin at block 705. At block 705, a central information source receives an indication responsive to a mobile device receiving an information carrying tone which has been previously associated with terms and conditions or other program information, as is described above with reference to FIG. 6.

Following block 705 is block 710, in which the central information source may identify a particular program with which the tone is associated. According to one example embodiment, the central information source may store a location or other unique identifier in a memory, associated with terms and conditions information, such as in a look-up table, relational database, or other data storage means. According to another embodiment, the central information source may just store an identifier associated with one or more third party information sources, enabling the central information source to identify a third party information source and transmit the identifier for further processing, which may optionally reply with associated promotional information and/or continue promotion processing directly with the mobile device or operator.

Following block 710 is block 715, in which the central information source may associate the operator of the mobile device (or associate the mobile device) with the program data identified in block 710. For example, the central information source at block 705 may store in memory mobile device identifiers (e.g., telephone number, a UICC identifier, a SIM card identifier, a IMSI number, etc.) and/or operator identifiers (e.g., a telephone number, name, username, email address, account number, etc.). In another example, the mobile device identifier alone may be used to identify the operator, and no further association with the operator may be performed. The mobile device identifier and/or operator identifier may be provided automatically as part of the message received from the mobile device, such as at block 705, may be provided in one or more separate messages, or may be previously stored in memory, such as if the operator is already registered with the central information source (or other entity). According to one example, the mobile device may include programming instructions and a user profile, such as the tone processing application 137 and the user profile 138 described with reference to FIG. 1, which together are operable to retrieve mobile device identifiers and/or operator identifiers stored in the user profile and include in one or more messages transmitted to the central information source (or other information source). In other examples, one or more messages transmitted to an information source may automatically include an identifier, such as a telephone number.

By associating the operator (or the mobile device) with the terms and conditions data, the central information source and any subsequent third party information sources will have a record of which operator received terms and conditions information. Such a record may be used to immediately to facilitate program enrollment processing, or may be used subsequently, such as during follow-up marketing and/or reporting.

Following block 715 is block 720, in which the central information source can optionally receive additional information associated with the operator, according to one embodiment. For example, the central information source may request additional information about the operator from one or more sources, and receive a response thereto. Various sources that may maintain and provide additional operator information can include, but are not limited to, the operator's telecommunications provider (e.g., mobile network operator, cellular carrier, etc.), a third party registry of information, an account provider (e.g., financial, loyalty, membership, etc.), or any other third party or third party information source. In example embodiments, the additional operator information may automatically be transmitted as part of the communications from the mobile device to the central information source, such as if the additional information is being provided by a telecommunications provider and it adds or otherwise provides the information. Though, in other embodiments, the central information source may generate a request, such as over a network, and receive the additional operator information.

Following block 720 is block 725, in which the central information source may determine one or more third party information sources associated with the program identified at block 710. As described above, the central information source may store in a memory an association between the tone and a third party associated with the respective program.

Following block 725 is block 730, in which the central information source may transmit a message to the third party information source identified at block 725. In various embodiments, the message may include the information received with the indication at block 705, such as one or more location or other unique identifiers, any program data that may be stored by the central information source and retrieved at block 710, an operator or mobile device identifier determined at block 715, and/or additional operator information received at block 720.

According to one embodiment, the central information source may just transmit the location or other unique identifier and/or other terms and conditions identifying information with an operator identifier, leaving any additional communications and transaction processing to the third party information source. For example, the third party information source may then communicate directly with the mobile device (or with the operator by any other means) to provide additional program information and/or to determine whether the operator accepts the terms and conditions and wishes to enroll in the program. Accordingly, no further processing and/or communications would be required by the central information source. Though, in one embodiment, the third party information source may communicate a status update to the central information source for reporting, record keeping, and the like.

According to another embodiment, the central information source may act more as an intermediary between the mobile device and the third party information source. For example, upon receiving the indication that the mobile device has received the tone, the central information source may transmit the location identifier and/or other terms and conditions identifying information with an operator identifier, and receive subsequent instructions and/or messages from the third party information source for relaying to the mobile device operator.

According to yet another embodiment, the central information source may perform much of the transaction processing, including providing additional program information to the mobile device and/or operator, determining whether the operator wishes to enroll, and the like, and transmit status updates and/or confirmations to the third party information source. Thus, according to this embodiments, the messages transmitted at block 730 may be updates or may require minimal processing by the third party information source.

Following block 730 is block 735, in which the central information source may optionally receive communications from the third party information source in response to the communications sent in block 730. According to one embodiment, the third party information source may transmit message information to be sent by the central information source to the mobile device, such as additional program information, terms and conditions details, enrollment information, and the like. According to another embodiment, the third party information source may transmit status updates to the central information source in response to communicating directly with the mobile device.

In one embodiment, the central information source may store information contained in the communications received at block 735 in a memory. For example, the information received may be stored for subsequent retrieval and transmission to the mobile device. In another example, the information received may be stored for reporting, transaction tracking, and/or subsequent marketing communications.

Following block 735 is block 740, in which the central information source may optionally transmit additional information to the operator. As described above, the information may be transmitted to the operator via the mobile device or by any other means, such as over the Internet via a website, a telephone message, an email, and the like. According to one embodiment, the additional information may include terms and conditions data and/or additional program information identified by the central information source when performing additional transaction processing in response to receiving the indication at block 705. According to another embodiment, the additional information may be received from the third party information source at block 735 and transmitted to the mobile device by the central information source. Although, as described above with reference to block 730, in some embodiments, the third party information source may perform all or most of the additional communications with the mobile device and/or the operator such that block 740 may not be performed by the central information source.

In various embodiments, blocks 730-740 may be repeated to permit multiple messages be transmitted between the central information source and the third party information source and/or with the mobile device.

The method 700 may end after block 740, having divided some of the transaction processing tasks between the central information source and one or more third party information sources.

Accordingly, example embodiments provide systems and methods that permit communicating terms and conditions, program enrollment information, and other associated program information to a mobile device, responsive to transmitting an information carrying tone associated with the program information. By associating program information with a tone, more potential customers may be reached, due to the simplicity of interacting with the mobile device and the immediate results made possible by real-time messaging with central and/or third party information sources. Moreover, entities may benefit from having obtained a customer's express acceptance of program conditions, such as by affirmatively responding to receiving a tone, additional program information, and the like, providing proof of “opting-in” and binding acceptance of the conditions provided therein. Furthermore, the real-time messaging provides the possibility of immediate enrollment of customers into a program and thus immediate benefits to the customers and to the entity associated with the program. For example, such an immediate and simple enrollment process may encourage the customer to actually participate in the program at the time of enrolling, thus likely improving the chances of repeat use and driving customer loyalty.

Example embodiments provide the technical effects of systems and methods for communicating terms and conditions, program enrollment information, and other program information to a mobile device operator, whereby the aforementioned information can be transmitted in response to transmitting one or more tones to the mobile device that are associated with such information. Additional technical effects include providing mobile devices operable to receive tones, extract one or more identifiers therefrom, and to perform additional processing, display, and messaging related to program information associated with the extracted identifiers. Moreover, additional technical effects include one or more information sources configured to store and associate identifiers with program information, communicate with mobile devices, communicate with other information sources, and perform additional processing to facilitate enrolling mobile device operators in one or more programs based on the information communicated by or otherwise associated with the identifiers.

Embodiments of the invention have been described herein with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

In certain embodiments, performing the specified functions, elements or steps can transform an article into another state or thing. For instance, example embodiments can provide certain systems and methods that transform a tone or multiple tones to a program enrollment request, as described above. Example embodiments can provide the further systems and methods for that transform a tone or multiple tones to enroll a consumer in an actual program, which can include transforming one or more tones into program terms presentable to the consumer and acceptable or deniable by the consumer, as described above.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for communicating program information to a mobile device, comprising executing computer-executable instructions performed by one or more processors for:
associating program information for a program with an information carrying tone that is transmitted to a mobile device associated with an operator by a tone transmission device;
receiving, by an information source, an indication responsive to the mobile device receiving the information carrying tone; and
storing, by the information source, at least one entry associating the program and the operator responsive to receiving the indication.

2. The method of claim 1, wherein receiving the indication comprises receiving at least one location identifier extracted from the information carrying tone, and further comprising:
retrieving additional program information based at least in part on the at least one location identifier;
transmitting the additional program information to the operator.

3. The method of claim 2, wherein transmitting the additional program information to the operator comprises transmitting the additional program information to the mobile device.

4. The method of claim 2, wherein the additional program information comprises at least one of: terms and conditions information representing terms and conditions of the program or enrollment information for enrolling with the program.

5. The method of claim 1, wherein the program information comprises terms and conditions information representing terms and conditions of the program, and further comprising determining that the operator accepts or declines the terms and conditions.

6. The method of claim 5, wherein determining that the operator accepts or declines the terms and conditions comprises determining that the operator accepts or declines the terms and conditions based at least in part on the indication.

7. The method of claim 6, wherein the indication comprises one of: an indication that the operator accepts the terms and conditions, or an indication that the operator declines the terms and conditions.

8. The method of claim 7, wherein receipt of the indication signifies that the operator accepts the terms and conditions.

9. The method of claim 5, further comprising receiving, by the information source, an input provided by the operator comprising one of: an indication that the operator accepts the terms and conditions, or an indication that the operator declines the terms and conditions, and wherein determining that the operator accepts or declines the terms and conditions is based at least in part on the input.

10. The method of claim 1, wherein receipt of the indication signifies a request to enroll in the program.

11. The method of claim 1, further comprising receiving, by the information source, an input provided by the operator comprising a request to enroll in the program.

12. The method of claim 1, further comprising enrolling the operator in the program in response to receiving at least one of: the indication or an input provided by the operator comprising a request to enroll in the program.

13. A method for communicating program information to a mobile device, comprising executing computer-executable instructions performed by one or more processors for:
receiving, by a central information source, an indication from a mobile device associated with an operator, wherein the indication identifies an information carrying tone transmitted to the mobile device;
determining, by the central information source, that the information carrying tone is associated with program information; and
associating, by the central information source, the operator and the program information.

14. The method of claim 13, further comprising transmitting a message, from the central information source to a third party information source, identifying at least the operator and the program information.

15. The method of claim 14, further comprising receiving, by the central information source from the third party information source, an indication indicating at least one of: that the operator enrolled in the program, that the operator did not enroll in the program, that the operator accepted terms and conditions of the program, or that the operator declined the terms and conditions of the program.

16. The method of claim 14, further comprising:
receiving, by the central information source from the third party information source, at least one of: terms and conditions information representing terms and conditions of the program, or enrollment information for enrolling with the program; and
transmitting, to the operator, at least one of the terms and conditions information or the enrollment information.

17. The method of claim 13, further comprising:
receiving, by the central information source from at least one of a telecommunications provider or a first third party information source, additional information associated with the operator; and
transmitting, from the central information source to a second third party information source, the additional information associated with the operator.

18. A system for communicating a promotion to a mobile device, comprising:
a network interface operable to connect with a network;
memory comprising computer-executable instructions to communicate program information;
at least one processor in communication with the memory and the network interface, and operable to execute the computer-executable instructions to:
associate program information for a program with an information carrying tone that is transmitted to a mobile device associated with an operator by a tone transmission device;
receive an indication responsive to the mobile device receiving the information carrying tone; and
store in the memory at least one entry associating the program and the operator responsive to receiving the indication.

19. The system of claim 18, wherein the processor is further operable to execute the computer-executable instructions to:
receive at least one location identifier extracted from the information carrying tone;
retrieve additional program information based at least in part on the at least one location identifier;
transmit the additional program information to the operator, wherein the additional program information comprises at least one of: terms and conditions information representing terms and conditions of the program, or enrollment information for enrolling with the program.

20. The system of claim 19, wherein the processor is further operable to execute the computer-executable instructions to transmit the additional program information to the mobile device.

21. The system of claim 18, wherein the processor is further operable to execute the computer-executable instructions to enroll the operator in the program in response to receiving at least one of: the indication or an input provided by the operator comprising a request to enroll in the program.

22. The system of claim 18, wherein the processor is further operable to execute the computer-executable instructions to determine that the operator accepts terms and conditions for the program in response to receiving at least one of: the indication or an input provided by the operator comprising an acceptance of the terms and conditions.

23. The system of claim 18, wherein the processor is further operable to execute the computer-executable instructions to:
transmit, to a third party information source, information identifying the operator and the program; and
receive, from the third party information source, at least one of: terms and conditions information representing terms and conditions of the program, or enrollment information for enrolling with the program.

24. The system of claim 18, wherein the processor is further operable to execute the computer-executable instructions to:
transmit, to a third party information source, information identifying the operator and the program; and
receive, from the third party information source, an indication indicating at least one of: that the operator enrolled in the program, that the operator did not enroll in the program, that the operator accepted terms and conditions of the program, or that the operator declined the terms and conditions of the program.
